(19) United States
(12) Patent Application Publication
(10) Pub. No.: US 2026/0131760 A1
(43) Pub. Date: May 14, 2026

(54) COMPRESSED-AIR SUPPLY UNIT, COMPRESSED-AIR SUPPLY SYSTEM, VEHICLE AND OPERATING METHOD

(71) Applicant: ZF CV Systems Europe BV, Brussels (BE)

(72) Inventors: Uwe Stabenow, Laatzen (DE); Jörg Meier, Hessisch Oldendorf (DE)

(21) Appl. No.: 19/445,149

(22) Filed: Jan. 9, 2026

Related U.S. Application Data
(63) Continuation of application No. PCT/EP2024/069598, filed on Jul. 11, 2024.

(30) Foreign Application Priority Data
Jul. 26, 2023 (DE) 10 2023 119 855.6

(51) Int. Cl. B60S 1/54; B01D 53/26; B60R 16/08; B60S 1/56; F15B 21/048

(52) U.S. Cl. CPC B60S 1/54; B01D 53/265; B60R 16/08; B60S 1/56; F15B 21/048; B01D 2257/80; B01D 2258/06

(57) ABSTRACT

A compressed-air supply unit is for a sensor cleaning device and includes a compressed-air connection, a compressed-air supply connection, a main pneumatic line from the compressed-air connection to the compressed-air supply connection, and an air dryer arranged in the main pneumatic line. A water separator is arranged in the main line between the compressed-air connection and the air dryer. A branching line branches off from the main pneumatic line between the water separator and the air dryer and reconnects to the main pneumatic line between the air dryer and the compressed-air supply connection. The branching line has a pneumatic branching line switch valve which opens the branching line so as to allow a pneumatic flow in the direction of the compressed-air supply connection in a first operating mode. In the first operating mode, the compressed-air supply unit is configured to allow a recirculation of compressed-air out of the branching line.

### CROSS-REFERENCE TO RELATED APPLICATIONS

This application is a continuation application of international patent application PCT/EP2024/069598, filed Jul. 11, 2024, designating the United States and claiming priority from German application 10 2023 119 855.6, filed Jul. 26, 2023, and the entire content of both applications is incorporated herein by reference.

### TECHNICAL FIELD

The present disclosure relates to a compressed-air supply unit for a sensor cleaning device of a vehicle, in particular of a passenger car, with
a compressed-air port for connection to a compressed air generator,
a compressed-air supply port for connection to a compressed-air consumer, in particular a sensor cleaning device,
a pneumatic main line for conducting compressed air from the compressed-air port to the compressed-air supply port in a filling direction,
an air dryer, arranged in the pneumatic main line, for drying the compressed air, conducted in the filling direction, in the pneumatic main line, and
a throttle associated with the air dryer.

### BACKGROUND

In vehicles, compressed-air supply units are used to supply compressed air to compressed-air consumers. For this purpose, compressed air is supplied to the compressed-air supply unit via the compressed-air port from a compressed-air generator such as a pressurizer or compressor. Pressurizers and compressors are used as synonyms in the present description and refer to equipment that compresses air, that is, pressurizes air. Such a pressurizer forms a compressed-air supply system together with the compressed-air supply unit. The actuation of such a compressed-air supply system is preferably carried out via an electronic control unit (ECU). Such compressed-air supply systems are also used in particular to supply compressed air to sensor cleaning devices as compressed-air consumers. Preferably, such compressed-air supply systems are configured to supply compressed air with a supply pressure of 5 bar and a volume flow rate of preferably 30-100 l/min.

Sensor cleaning devices for vehicles are also known. Via a sensor cleaning device, surfaces on a vehicle, in particular sensor surfaces of sensors, can be cleaned via at least one cleaning fluid, for example compressed air. Via the cleaning of sensor surfaces on the vehicle, which is carried out in particular regularly, it can be achieved that sensors are less dirty and thus function more reliably. A clean sensor surface thus advantageously increases the reliability of driver assistance functions and/or partially autonomous and/or autonomous driving functions of a vehicle. The safety of the vehicle, its occupants, and other road users is thus advantageously increased by a sensor cleaning device.

Sensor cleaning devices which use compressed air as a cleaning fluid are connected to a compressed-air supply unit as compressed-air consumers. It is necessary to dry the compressed air supplied by the compressed-air supply unit for the sensor cleaning device in order to prevent corrosion and frost-related damage and functional impairment to lines, at the compressed-air supply unit and the sensor cleaning device, at temperatures below freezing point. The substrate in the air dryer is basically configured to adsorb moisture from the compressed air flowing through the air dryer, wherein the substrate can only adsorb moisture up to a maximum saturation. In order to maintain the operation of the air dryer, regeneration of the air dryer is therefore usually carried out either regularly or at the latest when the saturation limit is reached. Regeneration refers in the present case to the dehumidification of the substrate used in the air dryer for drying purposes. In order to dehumidify the substrate, drier air compared with the substrate must then be conducted through the air dryer. This drier air binds part of the adsorbed moisture and thus reduces the degree of saturation of the substrate. The operating time of the air dryer is limited by the saturation of the substrate situated in the air dryer. If there is no regeneration of the air dryer, achieving the maximum saturation of the substrate requires replacement of the air dryer or the substrate situated in the air dryer.

In the case of compressed-air supply units for sensor cleaning devices, there is a challenge that the compressed air supplied at the compressed-air supply port cannot be returned to the compressed-air supply unit and instead is ejected in order to clean the sensors. Thus, unlike with known compressed-air supply units, as shown for example in DE102017010772 A1, no compressed air which has already been dried by the air dryer remains which can be used for regeneration of the air dryer in the compressed-air supply unit or in the compressed-air consumer.

The operating time of the compressed-air supply unit for sensor cleaning devices therefore depends significantly on the possible operating time of the air dryer and its degree of saturation. The operating time of such a compressed-air supply unit can thus to date only be achieved by increasing the amount of substrate - that is, a larger air dryer. However, owing to space limitations, such a solution is perceived as a disadvantage.

### SUMMARY

It is an object of the disclosure to provide a compressed-air supply unit, a compressed-air supply system, a vehicle, and an operating method, which can overcome at least one of the disadvantages known from the prior art. In particular, it is an object of the present disclosure is to enable regeneration of the air dryer in a compressed-air supply unit of the type mentioned above, in particular compressed-air supply units for sensor cleaning devices without return of the compressed air supplied at the compressed-air supply port, and at the same time to achieve a compact configuration of the compressed-air supply unit.

In the case of a compressed-air supply unit, for in particular open pneumatic systems, according to the first aspect of the disclosure, the disclosure proposes a water separator arranged in the pneumatic main line between the compressed-air port and the air dryer, and a branch line departing from the pneumatic main line between the water separator and the air dryer and rejoining between the air dryer and the compressed-air supply port. The branch line has a pneumatic branch-line switching valve which is configured in a first operating mode to open the branch line so that air can flow through it pneumatically in the direction of the compressed-air supply port, wherein the compressed-air supply unit is configured in the first operating mode to allow return of compressed air from the branch line through the throttle counter to the filling direction. It should be understood that the pneumatic branch-line switching valve opens the branch line in a first operating mode so that air can flow through it pneumatically only in the direction of the compressed-air supply port and in particular blocks it in the opposite direction. A compressed-air supply system with such a compressed-air supply unit and a pneumatic unit, in particular a sensor cleaning device, form a pneumatic system.

The filling direction within the meaning of the disclosure refers to the direction of the compressed air, conducted through a line, from the compressed-air port to the compressed-air supply port. The pressurized line can be the pneumatic main line or a branch line configured to conduct compressed air to the compressed-air supply port. In embodiments in which the branch line is configured, in addition to the return of compressed air into the pneumatic main line, also to supply compressed air at the compressed-air supply port, the filling direction simultaneously describes the direction in which air can flow through the branch line in the first operating mode, that is, in this case, the filling direction corresponds to the direction of the compressed-air supply port.

The disclosure makes use of the fact that the saturation of the substrate in the air dryer is already slowed down by the water separator, which separates part of the moisture from the compressed air supplied at the compressed-air port. By opening the pneumatic branch-line switching valve as required in the first operating mode in such a way that air can flow pneumatically through the branch line in the direction of the compressed-air supply port, the compressed air from the branch line is conducted through the air dryer in the pneumatic main line counter to the filling direction, that is, in a return direction. By virtue of this flow counter to the filling direction, the compressed air partially dehumidified by the water separator can be used to regenerate the air dryer in the return direction.

The return direction within the meaning of the disclosure refers to the direction of the compressed air, conducted through a line, from the compressed-air supply port counter to the filling direction.

According to various embodiments, the compressed-air supply unit moreover includes a venting port for venting the compressed-air supply unit and a venting line, departing from the pneumatic main line, for conducting compressed air to the venting port. Pressure can thus be released from the compressed-air supply unit. According to this embodiment, the return direction describes in particular the direction of the compressed air, conducted through a line, from the compressed-air supply port to the venting port. The pressurized line can be the pneumatic main line or a branch line from which a venting line departs toward the venting port.

The compressed air reissuing from the air dryer counter to the filling direction is preferably discharged from the compressed-air supply unit via the venting line and the venting outlet. The venting line preferably has a pneumatic venting valve which is configured to cooperate with the pneumatic branch-line switching valve in the branch line in such a way that the venting valve switches into an opening position in the event that the pneumatic branch-line switching valve in the branch line is in the first operating mode.

According to various embodiments, the pneumatic branch-line switching valve is moreover configured to block the branch line in a basic operating mode. It is thus prevented in the basic operating mode that compressed air which is not completely dried is supplied via the branch line at the compressed-air supply port and fed to the sensor cleaning device. Frost-related malfunctions at the lines and malfunctions of the sensor cleaning device due to freezing residual moisture in the compressed air supplied are thus reliably avoided.

It can furthermore be preferred that the water separator has a condensation dryer for condensing moist compressed air and a drain element, in particular a drain valve for draining condensate. The compressed air supplied by the compressed-air generator, such as in particular a pressurizer or compressor, usually has high temperatures as a result of the pressurization. Parts of the water can expediently be separated by a condensation dryer from the hot compressed air by cooling the moist compressed air and finally discharged through a drain element. The drain valve is preferably an automatic drain valve. Preferably, such a condensation dryer has a liquid cooling system, in particular a water cooling system.

The branch-line switching valve is preferably a magnetic branch-line switching valve which is configured to be connected to an electronic control device by signals. The magnetic branch-line switching valve is preferably configured as a 2/2-way valve. The magnetic branch-line switching valve is particularly preferably configured as a valve which is closed when de-energized.

Such a control device preferably includes one or more communicating control units. Thus, for example, a first control unit can be configured to control the compressed-air consumer, a second control unit can be configured to control the compressed-air supply system, and a third control unit can be configured to control the compressed-air generator. The communication between such control units enables reliable data exchange and joint control of the compressed-air supply system and of the compressed-air consumer and of the compressed-air generator.

According to various embodiments, the compressed-air supply unit has an external ventilation unit associated with the water separator. The external ventilation unit particularly preferably includes a fan. The water separator is thus assisted by the ventilation unit when cooling the hot compressed air supplied at the compressed-air port. This thus results in stronger cooling of the hot compressed air and thus an increased degree of dehumidification.

According to various embodiments, the air dryer is a first air dryer and the compressed-air supply unit moreover includes a second air dryer arranged in the branch line. In addition to the dehumidification by the water separator, the air conducted through the first air dryer counter to the filling direction has thus been additionally dried by the second air dryer. The regeneration effect is thus significantly increased by a second air dryer by opening the branch line in the first operating mode so that air can flow through it pneumatically.

According to various alternative embodiments, the branch line is a first branch line and the air dryer is a first air dryer. The compressed-air supply unit moreover includes a second branch line, departing between the water separator and the first air dryer and rejoining between the air dryer and the compressed-air supply port, and a second air dryer arranged in the second branch line. The second branch line is configured to conduct compressed air from the compressed-air port to the compressed-air supply port in the filling direction. Thus, in parallel to the above described regeneration of the first air dryer via the first branch line, the compressed-air supply unit can also continue to supply dry compressed air via the second branch line with the second air dryer at the compressed-air supply port. The readiness for use of the compressed-air supply unit is thus increased. A constant supply of dry compressed air to the compressed-air supply port is thus enabled. The dried compressed air from the second branch line can moreover also be used as required for the regeneration of the first air dryer by returning the compressed air through the pneumatic main line counter to the filling direction.

According to various embodiments, the venting line is a first venting line and the compressed-air supply unit moreover has a second venting line, departing from the second branch line, for conducting compressed air to the venting port. By virtue of such a second venting line, the second air dryer can also be used by returning the compressed air, supplied by the first branch line and/or the pneumatic main line, through the second branch line counter to the filling direction. The compressed air reissuing from the second air dryer counter to the filling direction can be discharged through the second venting line associated with the second air dryer in accordance with the regeneration of the first air dryer.

In embodiments in which the branch line is a first branch line and a branch-line switching valve is also arranged in a second branch line which may be present, the corresponding branch-line switching valve in the first branch line is a first branch-line switching valve and the branch-line switching valve in the second branch line is a second branch-line switching valve. Preferably, the second pneumatic branch-line switching valve is configured in the first operating mode to open the branch line so that air can flow through it pneumatically in the direction of the compressed-air supply port.

Thus, in the first operating mode, the regeneration of the first air dryer can be supplied by compressed air from the first branch line and additionally compressed air from the second branch line, both of which are opened by the corresponding pneumatic branch-line switching valves so that air can flow through them pneumatically in the direction of the compressed-air supply port. The degree of regeneration and in particular the speed of the regeneration of the air dryer is thus significantly increased.

According to various embodiments, the pneumatic main line has a pneumatic main-line switching valve, arranged upstream of the air dryer in the filling direction, which is configured in the first operating mode to block the pneumatic main line in the filling direction. Thus, the return of the compressed air in the main line in the first operating mode is simplified and does not have to take place counter to the pressure present in the pneumatic main line. The main-line switching valve can preferably also be a controllable throttle which is configured to control the flow cross section of the pneumatic main line.

According to various embodiments, the compressed-air supply unit moreover has a main-line throttle, arranged in the pneumatic main line, which is configured to interact with the main-line throttle in order to set a volume flow ratio between the branch line and the pneumatic main line in the first operating mode. The main-line throttle is preferably a controllable throttle or a controllable throttle valve. The volume flow ratio between the compressed air conducted through the pneumatic main line and the branch line in the first operating mode can thus be controlled. A throttle check valve which is arranged upstream of the main-line throttle in the filling direction is moreover preferably associated with the main-line throttle. The throttle check valve is preferably configured to open at an opening pressure upstream of the main-line throttle in the filling direction which is higher than a pressure difference upstream and downstream of the main-line throttle.

According to various embodiments, the branch-line switching valve is arranged at a branching point at which the branch line branches off from the pneumatic main line, and is configured as a 3/2-way valve. The distribution of the compressed air partially dehumidified by the water separator can thus be controlled with just one switching valve. On the one hand, this compressed air is suitable for the regeneration of the air dryer and can be directed via the 3/2-way valve into the branch line and returned via the latter through the pneumatic main line counter to the filling direction. On the other hand, this compressed air is also suitable for further drying by the air dryer arranged in the pneumatic main line and can for this purpose be conducted into the pneumatic main line through the 3/2-way valve in the basic operating mode.

According to various embodiments, a pneumatic assembly is associated with the compressed-air supply port, which is configured in the first operating mode to allow return of compressed air from the branch line, in particular the first branch line and/or the second branch line, into the pneumatic main line counter to the filling direction. The pneumatic assembly is preferably configured in a second operating mode to distribute the compressed air from the branch line, in particular the first branch line and/or the second branch line, in such a way that a first portion of the compressed air is returned into the pneumatic main line counter to the filling direction and moreover a second portion of the compressed air is supplied at the compressed-air supply port. The second operating mode thus represents a distribution mode in which compressed air is distributed as required to the pneumatic main line for the regeneration of the air dryer and to the compressed-air supply port for supplying a compressed-air consumer. The pneumatic assembly is preferably configured to receive control signals and to set the first portion and the second portion depending on the received control signals. Consequently, the compressed-air consumer, such as a sensor cleaning device, can be supplied with compressed air to a sufficient extent and at the same time the regeneration of the air dryer can be carried out. The distribution of the first portion and the second portion can thus be optimized by control technology.

According to various embodiments, the pneumatic assembly preferably includes a controllable throttle valve which is configured to restrict compressed air conducted to the compressed-air supply port in the filling direction. For this purpose, the throttle valve preferably has a throttle point with a variable flow cross section. The throttle valve preferably has a control pressure line and is configured to regulate the flow cross section depending on the control pressure. The control pressure line preferably joins the pneumatic main line downstream of the throttle point. Alternatively, the throttle valve is preferably electrically controllable and configured to regulate the flow cross section by actuation via the control device. The throttle valve influences the compressed-air flow by changing the flow cross section in the pneumatic main line. If the valve reduces the flow cross section, this obstructs the flow of compressed air in the pneumatic main line, as a result of which the resistance to the compressed-air flow is increased. This in turn increases the back pressure upstream of the throttle point. The throttle valve is configured to restrict the pressure at the supply port, that is, downstream of the throttle valve, to the supply pressure and/or the volume flow. The pressure is restricted to the supply pressure by reducing the flow cross section in the region of the throttle point and then relieving the pressure of the compressed air passing through the throttle point. If there is a maximum reduction of the flow cross section through the throttle valve, no more compressed air is directed to the supply port. For restricting the volume flow, the throttle valve cooperates in particular with a pressure relief valve such as a venting check valve arranged in the venting line, wherein the flow cross section in the throttle valve is reduced until the back pressure upstream of the throttle valve reaches the pressure relief valve and supplies a sufficient pressure for opening the valve. The venting check valve preferably opens at a pressure of at least 0.5 bar. By virtue of such control of the throttle valve, the input volume flow supplied at the compressed-air port can be divided into the supply volume flow for supply at the compressed-air port, and an excess portion which is returned counter to the filling direction for the regeneration of the air dryer.

According to various embodiments, the pneumatic assembly includes at least one first check valve opening in the filling direction and a bypass line, departing downstream of the check valve and rejoining upstream of the check valve, with a second check valve opening in the return direction, that is, counter to the filling direction. More preferably, the pneumatic assembly moreover includes a throttle valve, arranged in the bypass line downstream of the second check valve in the return direction, which is configured to restrict compressed air conducted to the air dryer counter to the filling direction. For this purpose, the throttle valve preferably has a throttle point with a variable flow cross section. The throttle valve preferably has a control pressure line and is configured to regulate the flow cross section depending on the control pressure. The control pressure line preferably joins the bypass line downstream of the throttle point in the return direction, that is, counter to the filling direction. The first check valve is preferably arranged in the pneumatic main line, wherein the first check valve and the second check valve are arranged between the (first) air dryer and the compressed-air supply port. Alternatively or additionally, the first check valve is preferably arranged in the (second) branch line, wherein the first check valve and the second check valve are arranged between the second air dryer and the compressed-air supply port. The compressed air thus necessarily has to pass through the controllable throttle valve for return in the branch line or the pneumatic main line, which throttle valve is configured to restrict the pressure of the compressed air flowing to the respective air dryer. This compressed air is then, according to a preferred embodiment, conducted via a throttle arranged downstream of the air dryer in the filling direction and its pressure is further relieved by said throttle. The accompanying relief of the pressure of the compressed air reduces its relative humidity.

According to various embodiments, the pneumatic assembly is configured in a third operating mode to allow return of compressed air from the first branch line and/or the pneumatic main line into the second branch line counter to the filling direction. Regeneration of the second air dryer can thus moreover be controlled via the pneumatic assembly.

According to various embodiments, the pneumatic assembly thus preferably assumes a distribution function of the compressed air conducted in the direction of the compressed-air supply port as required for the regeneration of the first air dryer in the first operating mode and/or for the regeneration of the second air dryer in the third operating mode and/or for supply at the compressed-air supply port for a compressed-air consumer in the basic operating mode or in the second operating mode.

According to various embodiments, the throttle is arranged in the (first) branch line, in particular upstream of the (first) branch-line valve. More preferably, the throttle is a first throttle, and a second throttle is arranged in the second branch line, in particular upstream of the second branch-line valve. On the one hand, the pressure of the compressed air is sufficiently relieved by a throttle already arranged in the branch line upstream of the respective throttle valve in order to allow regeneration of the air dryer in the case of return through the pneumatic main line. On the other hand, relieving the pressure of the compressed air already upstream of the branch-line valve results in protection of the branch-line valve and the branch line from frost-related malfunctions because the compressed air already has a reduced relative humidity upstream of the branch valve owing to the pressure relief.

According to various embodiments, the compressed-air supply unit preferably moreover includes a pressure sensor, arranged at or in the pneumatic main line upstream of the air dryer and/or the departing branch line in the filling direction, which is configured to detect the pressure in the pneumatic main line. The pressure in the pneumatic main line can thus be monitored, wherein the pressure sensor preferably communicates with the electronic control device and at least one of the branch-line switching valves and/or the pneumatic assembly is controlled on the basis of the signals supplied by the pressure sensor.

In order to achieve the object, the disclosure relates in a second aspect to a compressed-air supply system, in particular for an open pneumatic system. A compressed-air supply system for a sensor cleaning device of a vehicle, in particular a car, according to the second aspect includes a compressed-air generator, in particular a pressurizer, for supplying compressed air at a compressed-air port, and a compressed-air supply unit, connected to the compressed-air generator via the compressed-air port, for supplying compressed air for a sensor cleaning device. The object mentioned above is achieved in such a compressed-air supply system by the compressed-air supply unit being configured according to the first aspect of the disclosure. Preferred embodiments and advantages which have been described with respect to the first aspect of the disclosure are therefore also advantages and preferred embodiments of the second aspect of the disclosure, and vice versa.

According to various embodiments, the compressed-air supply system preferably moreover includes a pressure sensor, arranged between the water separator and the air dryer, in particular between the water separator and the main-line switching valve, which is configured to detect the pressure upstream of the air dryer in the filling direction. The pressure of the compressed air, which is conducted to the air dryer or into the branch line and is dehumidified by the water separator, can thus be monitored. The pressure sensor preferably communicates with the electronic control device and at least one of the branch-line switching valves and/or the pneumatic assembly is controlled on the basis of the signals supplied by the pressure sensor.

According to various embodiments, the compressed-air supply system preferably moreover includes an additional compressed-air source, wherein the control device is configured to connect the compressed-air source to the pneumatic main line as required. An additional compressed-air source is thus added in addition to the compressed-air generator. The available compressed air quantity, that is, the available volume flow, is increased by an additional compressed-air source and it is possible to react to varying system requirements.

According to various embodiments, the compressed-air source is furthermore preferably configured to supply an input pressure above the supply pressure of, for example, 5 bar at the compressed-air port. The efficiency of the water separator and thus of the pre-drying of the compressed air is improved by the increased input pressure such that the addition of the compressed-air source to increase the input pressure slows down the saturation of the air dryer. In detail, the temperature of the compressed air supplied by the pressurizer, and thus also the quantity of water per m³, increases as a result of the increased input pressure. Owing to the higher temperature, it is easier to cool the compressed air in the water separator to temperatures below the condensation temperature as the condensation temperature increases as a result of the concomitant increase in the quantity of water per m³ of compressed air.

According to various embodiments the compressed-air generator is a first pressurizer and the compressed-air source moreover includes a second pressurizer which is configured to supply compressed air at the compressed-air port. By virtue of the presence of two pressurizers, compressed air can be supplied with an increased volume flow as well as an increased pressure at the compressed-air port, or the compressed-air generator can be switched off as required, compressed air preferably being supplied by the pressurizer. Alternatively or additionally, the compressed-air source includes a reservoir which is fluidically connected to the pneumatic main line and/or the second branch line. By virtue of such a reservoir, compressed air with an increased volume flow and an increased pressure can be supplied at the compressed-air port, or the compressed-air generator can be switched off as required, wherein compressed air is preferably supplied by the compressed-air source, that is, the reservoir.

In order to achieve the object, the disclosure relates in a third aspect to a vehicle with a compressed-air supply system. A vehicle, in particular a car, according to the third aspect of the disclosure includes a compressed-air consumer, in particular a sensor cleaning device connected to a compressed-air supply port, a compressed-air supply system for supplying compressed air in the compressed-air supply port, and an electronic control device for controlling the compressed-air supply system. The object mentioned above is achieved in a third aspect by the fact that the compressed-air supply system of the vehicle is configured according to the second aspect of the disclosure and moreover by the fact that the electronic control unit (ECU) is connected at least to the pneumatic branch-line switching valve, in particular to a first pneumatic branch-line switching valve and/or to a second pneumatic branch-line switching valve, using control technology. The control device can thus enable the unblocking of the branch line in the direction of the compressed-air supply port as required in order to allow regeneration of the air dryer. Preferred embodiments and advantages which have been described with respect to the second aspect of the disclosure are therefore also advantages and preferred embodiments of the third aspect of the disclosure, and vice versa.

According to various embodiments, the control device is connected to a venting valve in a venting line departing from the pneumatic main line using control technology. The control device is preferably configured to control the supply pressure supplied by the compressed-air supply unit at the compressed-air supply port depending on the input pressure detected by the pressure sensor, in particular at the compressed-air port. It is thus possible, for example, to react to changing requirements of the compressed-air consumers. The maximum supply pressure is preferably 5 bar. In particular, however, the compressed-air supply unit can also be fed with a pressure above the supply pressure of 5 bar. As a result, as described above, the temperature of the compressed air supplied at the compressed-air port and its humidity per m3 of compressed air increases, as a result of which the efficiency of the water separator is improved.

According to various embodiments, the control device is also configured for actuating the pneumatic assembly and can thus also control the distribution of the compressed air for supply at the compressed-air supply port for a pressure consumer, and the return for regenerating the air dryer.

According to various embodiments, the control device is moreover preferably configured for actuating the pneumatic main-line switching valve and connected to the pressure sensor by signals.

The actuation of a switching valve for blocking a pneumatic line can be understood to mean energization and de-energized switching, that is, the absence of energization, depending on the configuration of the respective valve. Accordingly, actuation of a switching valve for unblocking a pneumatic line can be understood to mean energization and de-energized switching depending on the configuration of the respective valve.

According to various embodiments, the control device is preferably configured to connect the compressed-air source to the pneumatic main line as required, depending on the supply requirement of the compressed-air consumer. An increased supply demand in relation to the supply volume flow can occur, for example, when all the nozzles of a sensor cleaning device are to be supplied with compressed air. Because the control device can, depending on this supply requirement, add an additional compressed-air source, it is possible to react to such supply requirements and a sufficient supply volume flow with the supply pressure for the supply of all the nozzles can be supplied.

According to various embodiments, the control device is configured to connect the compressed-air source to the pneumatic main line as required, depending on sensor signals. The compressed-air supply system preferably includes at least one temperature sensor which is configured to monitor a temperature of the compressed-air generator, in particular the pressurizer or compressor, and to supply sensor signals, wherein the control device is connected to the temperature sensor by signals. It may be necessary to switch off the compressed-air generator in the event of imminent overheating. By adding the compressed-air source depending on the sensor signals of the temperature sensor monitoring the compressed-air generator, such imminent overheating can be detected and the operation of the compressed air supply system can still be maintained by the compressed-air source.

Alternatively or additionally, the control device is preferably configured to monitor a degree of saturation of the air dryer and, depending on the degree of saturation of the air dryer, to connect a or the compressed-air source to the pneumatic main line as required. Furthermore, a volume flow at the compressed-air port, that is, an input volume flow, above the supply volume flow of, for example, 30 l/min can preferably moreover be supplied by addition of the compressed-air source. An increased input volume flow which is above the supply volume flow to be supplied at the compressed-air supply port is particularly advantageous in the regeneration of the first or second air dryer or in the simultaneous regeneration of the air dryer and supply of compressed air at the compressed-air supply port. The efficiency of the regeneration is improved by the increased input volume flow such that the addition of the compressed-air source is advantageous, in particular in the case of high saturation or a high degree of saturation. In this way, the degree of saturation can be quickly reduced. Particularly advantageously, two air dryers can be regenerated at the same time by adding the compressed-air source for supplying an input volume flow above the supply volume flow.

According to various embodiments, one, a plurality, or all of the following are configured as solenoid directional control valves which are closed when de-energized:
the at least one main-line switching valve,
the at least one branch-line switching valve,
at least one nozzle valve of a sensor cleaning device connected to the compressed-air supply unit,
the at least one venting valve, and
a compressor venting valve,
wherein the solenoid directional control valves have a coil for generating a magnetic force and an armature which is movable by the magnetic force counter to a spring force acting in the direction of a valve seat, and are configured to be moved away from the valve seat counter to the spring force by energization with an opening control current, and to be applied to the valve seat by energization with a heating control current which is less than the opening control current, wherein the coil is configured to heat the solenoid directional control valves when the heating control current is applied. The possibility of heating the mentioned valves reduces the risk of frost-related malfunctions of the pneumatic system as a whole. In addition to the sensor cleaning device or other compressed-air consumers, this also applies in particular to the compressed-air supply unit.

According to various embodiments, the control device is moreover preferably configured to selectively energize one, a plurality, or all of the following solenoid directional control valves with an opening control current and a heating control current:
the at least one main-line switching valve,
the at least one branch-line switching valve,
the at least one nozzle valve,
the at least one venting valve, and
a compressor venting valve.

The possibility of heating the mentioned valves reduces the risk of frost-related malfunctions of the pneumatic system as well as an overall functional impairment. In addition to the sensor cleaning device or other compressed-air consumers, this also applies in particular to the compressed-air supply unit. The use of the already present coil of the solenoid directional control valves makes it possible to dispense with additional heating elements. It should be understood that heating of the solenoid directional control valves is necessary in particular before opening since they remain in the closed state for longer periods of time. Functional impairment due to icing is a threat in particular when an iced-up valve or its armature is to be moved by actuation. Energizing the solenoid directional control valve before it actually opens prevents freezing by heating of the valve, which preferably takes place permanently during operation.

According to various embodiments, the compressed-air supply unit, particularly preferably the pressurizer and/or the water separator, in particular at least the separation valve, is preferably arranged in a front region, in the direction of travel, of the vehicle. The compressed-air supply unit and in particular the pressurizer and/or the water separator are thus additionally cooled by the wind from driving and the condensation of the compressed air supplied at the compressed-air port and pressurized by the pressurizer is further optimized in the water separator.

The disclosure moreover relates in a fourth aspect to a method in order to achieve the object. A method according to the fourth aspect of the disclosure for operating a compressed-air supply system, in particular a compressed-air supply system according to the second aspect of the disclosure, includes the steps:
a) providing compressed air at a compressed-air port which is connected to a compressed-air supply port via a pneumatic main line,
b) separating water from the compressed air supplied at the compressed-air port in order to supply dehumidified compressed air,
c) drying the dehumidified compressed air conducted to the compressed-air supply port in a filling direction with an air dryer arranged in the pneumatic main line in a basic operating mode,
d) opening a branch line so that air can flow through it pneumatically in the direction of the compressed-air supply port via a pneumatic branch-line switching valve in a first operating mode,
e) returning dehumidified compressed air from the branch line through the pneumatic main line counter to the filling direction in the first operating mode.

By opening the branch line so that air can flow through it pneumatically in the direction of the compressed-air supply port and returning dehumidified compressed air from the branch line through the pneumatic main line counter to the filling direction, the method according to the fourth aspect of the disclosure acquires the advantages described with respect to the first aspect of the disclosure. Preferred embodiments and advantages which have been described with respect to the first aspect of the disclosure are therefore also advantages and preferred embodiments of the fourth aspect of the disclosure, and vice versa.

According to various embodiments, it is furthermore preferred that the method moreover includes at least one of the following steps:
f) blocking the branch line via the pneumatic branch-line switching valve in the basic operating mode,
g) distributing compressed air from the branch line in a second operating mode such that a first portion of the compressed air is returned into the pneumatic main line counter to the filling direction and a second portion of the compressed air is moreover supplied at the compressed-air supply port,
wherein step g) preferably includes receiving control signals and controlling the first portion and the second portion depending on the received control signals by a pneumatic assembly,
h) returning compressed air from a first branch line and/or the pneumatic main line into a second branch line counter to the filling direction to a second air dryer in a third operating mode,
i) relieving the pressure of compressed air returned in the pneumatic main line counter to the filling direction,
j) relieving the pressure of compressed air returned in the second branch line counter to the filling direction.

### BRIEF DESCRIPTION OF DRAWINGS

The invention will now be described with reference to the drawings wherein:

FIG. 1 shows a compressed-air supply system in a perspective view;

FIG. 2A shows a compressed-air supply unit for a compressed-air supply system in accordance with FIG. 1 according to a first embodiment in a basic operating mode;

FIG. 2B shows the compressed-air supply unit in accordance with FIG. 2A in a first operating mode;

FIG. 3A shows a compressed-air supply unit for a compressed-air supply system in accordance with FIG. 1 according to a second embodiment in a basic operating mode;

FIG. 3B shows the compressed-air supply unit in accordance with FIG. 3A in a first operating mode;

FIG. 3C shows the compressed-air supply unit in accordance with FIG. 3A in a sleep mode;

FIG. 4A shows a compressed-air supply unit for a compressed-air supply system in accordance with FIG. 1 according to a third embodiment in a basic operating mode;

FIG. 4B shows the compressed-air supply unit in accordance with FIG. 4A in a first operating mode;

FIG. 5A shows a compressed-air supply unit for a compressed-air supply system in accordance with FIG. 1 according to a fourth embodiment in a basic operating mode;

FIG. 5B shows the compressed-air supply unit in accordance with FIG. 5A in a first operating mode;

FIG. 6A shows a compressed-air supply unit for a compressed-air supply system in accordance with FIG. 1 in a fifth embodiment in a basic operating mode;

FIG. 6B shows the compressed-air supply unit in accordance with FIG. 6A in a first operating mode;

FIG. 6C shows the compressed-air supply unit in accordance with FIG. 6A in a second operating mode;

FIG. 6D shows the compressed-air supply unit in accordance with FIG. 6A in a third operating mode;

FIG. 7 shows a compressed-air supply unit for a compressed-air supply system in accordance with FIG. 1 in a sixth embodiment in a first operating mode;

FIG. 8 shows a compressed-air supply unit for a compressed-air supply system in accordance with FIG. 1 in a seventh embodiment in a first operating mode;

FIG. 9 shows a vehicle with a compressed-air supply system schematically in a first embodiment;

FIG. 10 shows a vehicle with a compressed-air supply system schematically in a second embodiment;

FIG. 11 shows a vehicle with a compressed-air supply system schematically in a third embodiment;

FIG. 12 shows a solenoid directional control valve for a vehicle in accordance with FIGS. 7 to 11;

FIG. 13A shows a first embodiment of a pneumatic assembly;

FIG. 13B shows a second embodiment of a pneumatic assembly;

FIG. 13C shows a third embodiment of a pneumatic assembly;

FIG. 13D shows a fourth embodiment of a pneumatic assembly; and,

FIG. 14 shows schematically a method for operating a compressed-air supply system in accordance with FIG. 1.

### DETAILED DESCRIPTION

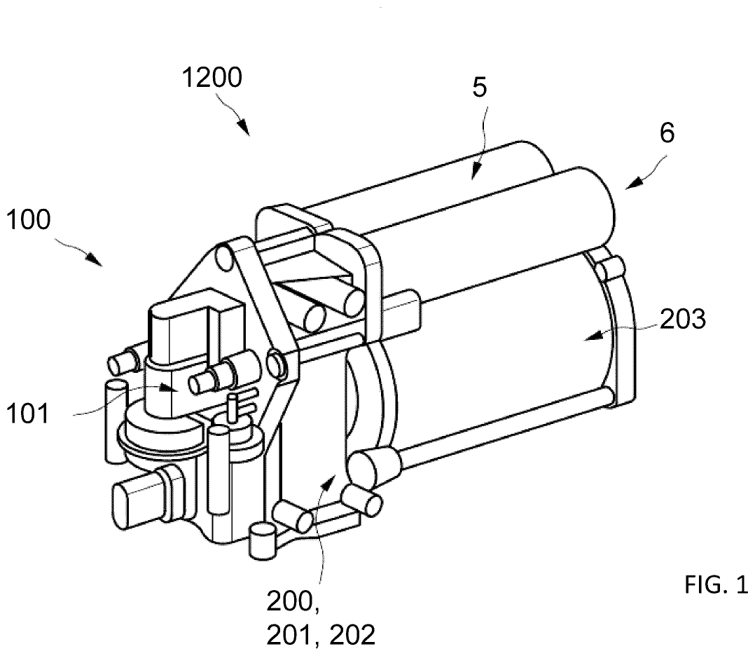

The compressed-air supply system 1200 in accordance with FIG. 1 includes a compressed-air supply unit 100. The compressed-air supply system 1200 moreover includes a compressed-air generator 200 which is preferably configured as a pressurizer 201 or compressor 202. The compressor 202 is driven by an electric motor 203.

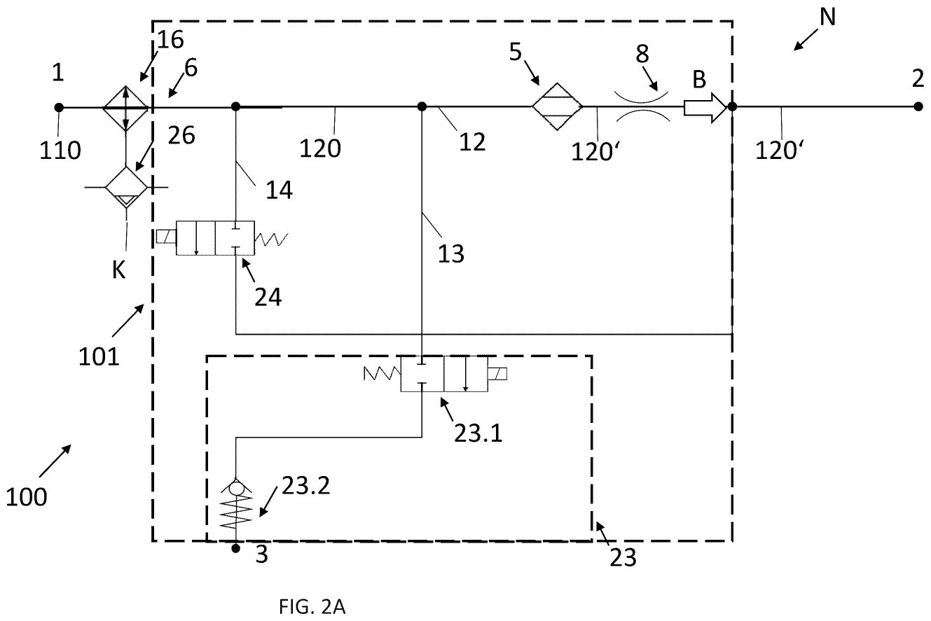

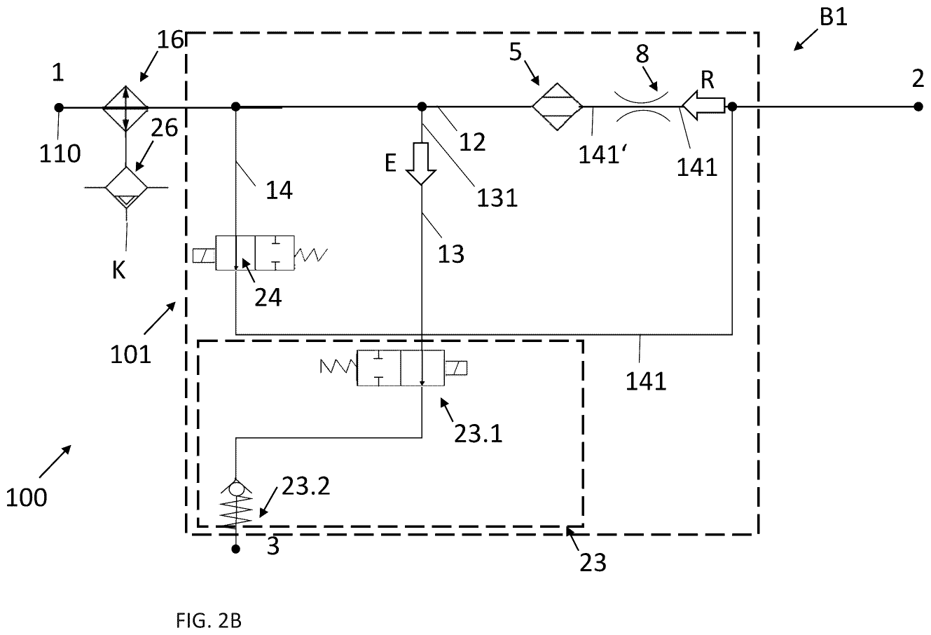

The compressed-air supply system 1200 is connected via a compressed-air port 1 (cf FIG. 2A to FIG. 11) to the compressed-air generator 200. The compressed-air supply unit 100 includes an air dryer 5 arranged in a pneumatic main line 12 (cf FIG. 2A to FIG. 11) and a water separator 6 arranged between the air dryer 5 and the compressed-air port 1 (cf FIG. 2A to FIG. 11). The compressed-air supply unit 100 moreover includes a pressure control module 101 which has a number of pneumatic branch-line switching valves (not shown) for distributing the pressure within the compressed-air supply unit 100.

The functioning of the compressed-air supply system 1200 and in particular the compressed-air supply unit 100 is described below based on preferred embodiments in FIG. 2A to FIG. 11.

Here FIGS. 2A and 2B show a first embodiment of the compressed-air supply unit 100.

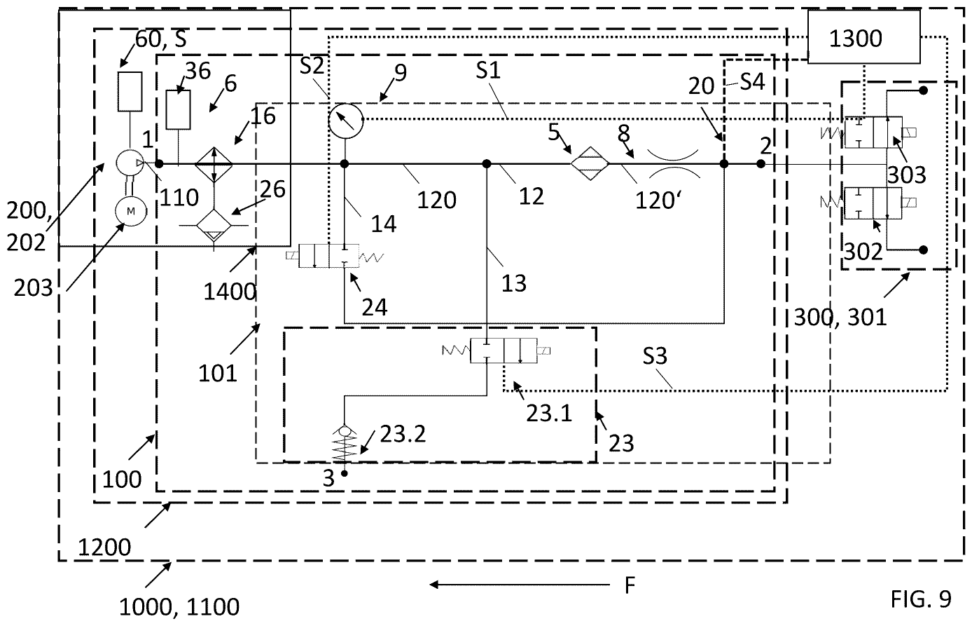

The compressed-air supply unit 100 includes a compressed-air port 1 for connection to a compressed-air generator 200 (cf FIG. 1) and a compressed-air supply port 2 for connecting a compressed-air consumer 300 (cf FIG. 9 to FIG. 11). The compressed-air port 1 is connected to the compressed-air supply port 2 via a pneumatic main line 12. A venting line 13 moreover departs from the pneumatic main line 12 to a venting port 3 which is configured to vent the pneumatic main line 12. The compressed-air supply unit 100 moreover includes an air dryer 5 arranged in the pneumatic main line 12. The air dryer 5 is configured for drying the compressed air 120 supplied at the compressed-air port 1 and conveyed in a filling direction B through the pneumatic main line. A water separator 6 is moreover arranged in the pneumatic main line 12 between the air dryer 5 and the compressed-air port 1. The water separator 6 includes a condensation dryer 16 and a drain valve 26 which are configured to discharge at least a portion of the moisture of the compressed air 110 supplied at the compressed-air port 1 as condensate K. Thus, compressed air 120 partially dehumidified by the water separator is supplied and the saturation of the air dryer 5 is slowed down by the partially dehumidified compressed air 120 in the pneumatic main line.

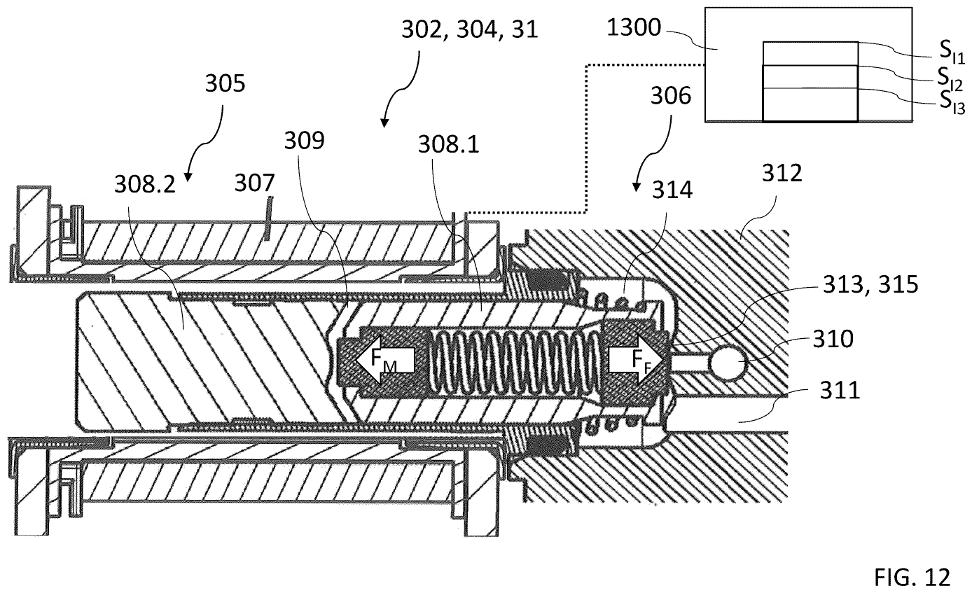

In the venting line 13, a venting valve assembly 23 is arranged which preferably includes an electrically controllable 2/2-way valve 23.1 in the form of a 2/2-way solenoid directional control valve 31 (cf FIG. 12). A venting check valve 23.2 of the venting valve assembly 23 which preferably opens, controlled by pressure, in the direction of the venting port 3 is moreover preferably arranged downstream of the venting valve 23.1 in the direction of the venting line 3. When the venting valve 23.1 is open, the venting check valve 23.2 thus preferably opens the venting line as a result of the compressed air situated in the venting line 13. At the same time, the venting check valve 23.2 prevents moisture from entering via the venting line 13. It should also be understood here that the venting line 13 can depart at any position between the water separator 6 and the air dryer 5.

The compressed-air supply unit 100 moreover includes a throttle 8. The throttle 8 is preferably arranged downstream of the air dryer 5 in the filling direction B (cf FIG. 2A). The throttle 8 is configured to restrict the compressed air 120′dried by the air dryer 5. Furthermore, the throttle 8 is configured to relieve the pressure of compressed air 141 (cf FIG. 2B) conducted counter to the filling direction B and thus reduce its relative humidity such that the pressure-relieved compressed air 141′ flows through the air dryer 5.

A branch line 14 moreover departs from the pneumatic main line 12 between the water separator 6 and the air dryer 5 and rejoins the pneumatic main line 12 between the air dryer 5 and the compressed-air supply port 2. The branch line 14 has a pneumatic branch-line switching valve 24 in the form of a 2/2-way solenoid directional control valve 31 (cf FIG. 12). The pneumatic branch-line switching valve 24 is preferably configured as an electrically controllable 2/2-way valve and as selectively switchable in such a way that the compressed-air supply unit 100 can be operated in a basic operating mode N in accordance with FIG. 2A and a first operating mode B1 in accordance with FIG. 2B.

The compressed-air supply unit 100 preferably has the pressure control module 101 shown in FIG. 1. The pneumatic branch-line switching valve 24 and the venting valve assembly 23 are associated with the pressure control module 101.

FIG. 2A shows the compressed-air supply unit 100 in a basic operating mode N. In the basic operating mode N, the pneumatic branch-line switching valve 24 is configured to block the branch line 14. In this state, the venting line 13 is also preferably blocked by the venting valve 23. Partially dehumidified compressed air 120 from the water separator 6 can thus flow exclusively through the pneumatic main line 12 in the filling direction B to the air dryer 5 before it is supplied as dried compressed air 120′ at the compressed-air supply port 2.

FIG. 2B shows the compressed-air supply unit 100 in a first operating mode B1. In the first operating mode, the branch-line switching valve 24 is configured to open the branch line 14 so that air can flow through it pneumatically only in the direction of the compressed-air supply port 2. Compressed air 141 can thus flow through the branch line 14 in the direction of the compressed-air supply port 2. The compressed-air supply unit 100 is configured in the first operating mode B1 shown to allow compressed air 141 to return from the branch line 14 in a return direction R counter to the filling direction B (cf FIG. 2A). It should be understood that the compressed-air supply unit 100 for this purpose inhibits or prevents the conducting of compressed air through the pneumatic main line 12 by virtue of its corresponding configuration.

In the first operating mode B1, the venting valve 23.1 preferably opens the venting line 13 such that the pneumatic main line 12 can be vented as required. The venting of the pneumatic main line 12 requires a sufficiently high pressure to open the venting check valve 23.2.

The compressed air 141 flowing through the branch line 14 is at least partially dehumidified by the water separator 6 and can thus be used in an advantageous manner for the regeneration of the air dryer 5. When the compressed air 141 is returned in the return direction R through the pneumatic main line 12, the compressed air 141 initially flows through the throttle 8 and its pressure is relieved. The relative humidity of the compressed air 141′, the pressure of which is relieved by the throttle 8, is further reduced by the pressure relief.

The pressure-relieved compressed air 141′ with reduced relative humidity from the branch line 14 then flows through the air dryer 5 in the return direction R and binds a portion of the moisture adsorbed by the air dryer 5. The moist compressed air 131 caused by the regeneration of the air dryer 5 is then discharged into the environment in the venting direction E via the venting line 13 and the venting port 3.

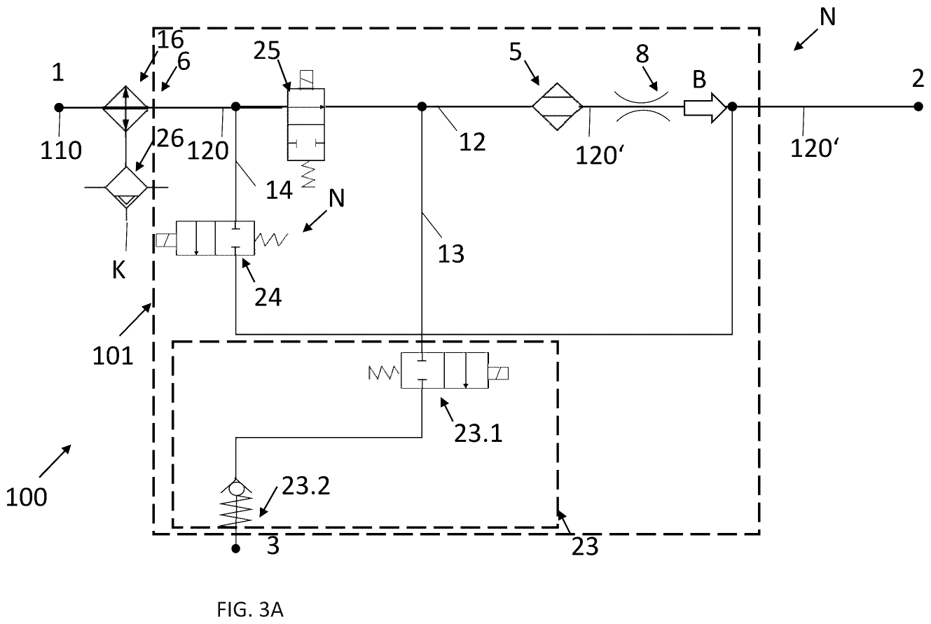

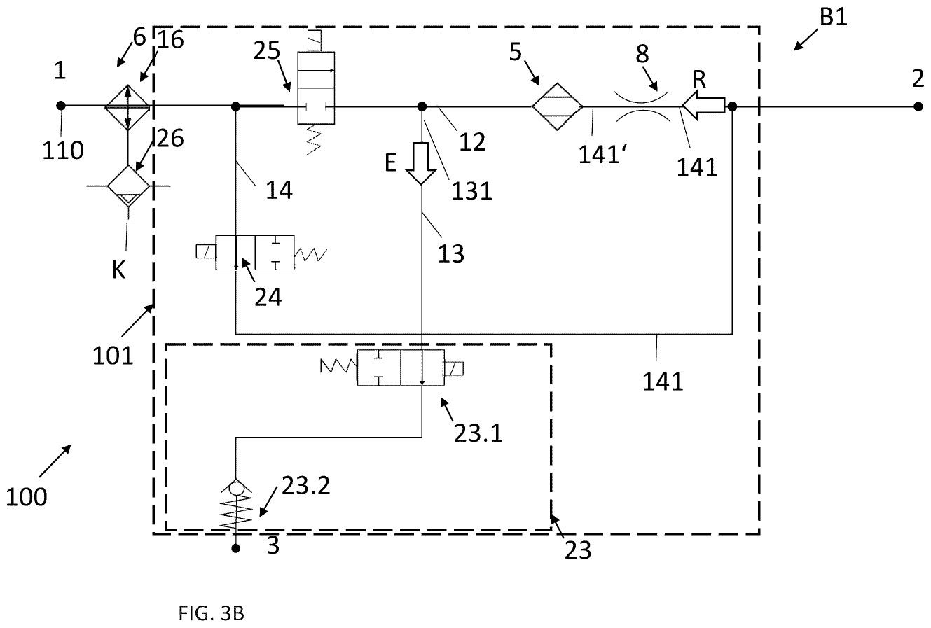

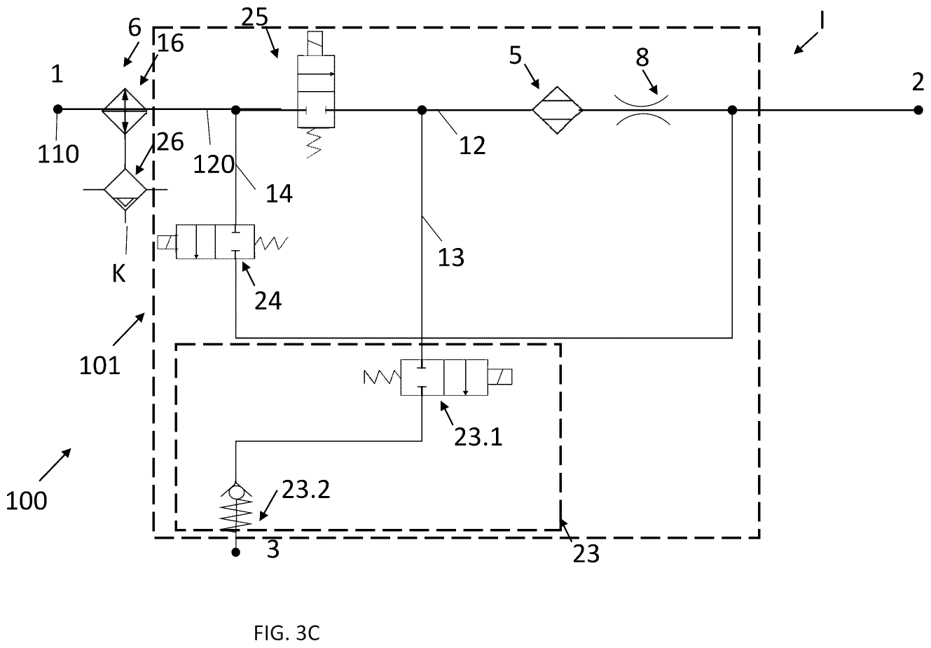

FIG. 3A to FIG. 3C show a second embodiment of the compressed-air supply unit 100. In this document, the same components have identical reference signs and, in order to avoid repetition, only the differences of the first and second embodiments of the compressed-air supply unit 100 are discussed.

The second embodiment of the compressed-air supply unit 100 is developed in that the pneumatic branch-line switching valve 24 is a first pneumatic branch-line switching valve 24 and the compressed-air supply unit 100 moreover has a pneumatic main-line switching valve 25, arranged in the pneumatic main line 12, in the form of a 2/2-way solenoid directional control valve 31 (cf FIG. 12). The pneumatic main-line switching valve 25 is also preferably configured as an electrically controllable 2/2-way valve and is configured to selectively open the pneumatic main line 12 in the basic operating mode N in the filling direction B (cf FIG. 3A) so that air can flow through it pneumatically.

The compressed-air supply unit 100 has the pressure control module 101 shown in FIG. 1. The pressure control module 101 is associated with the first pneumatic branch-line switching valve 24, the main-line switching valve 25, and the venting valve assembly 23.

In FIG. 3A, the compressed-air supply unit 100 is shown in the basic operating mode N, in which the first pneumatic branch-line switching valve 24 assumes a blocking position and blocks the branch line 14. Moreover, the venting valve 23.1 also assumes a blocking position in order to block the venting line 13. The partially dehumidified compressed air 120 can thus be conducted only in the filling direction B through the pneumatic main line 12 and be supplied as dry compressed air 120′ restricted at the compressed-air supply port 2.

In FIG. 3B, the compressed-air supply unit 100 is shown in the first operating mode B1, in which the first pneumatic branch-line switching valve 24 opens the branch line 14 so that air can flow through it pneumatically in the direction of the compressed-air supply port 2 such that compressed air 141 can flow through the branch line 14.

The main-line switching valve 25 is shown in an unenergized state in which it blocks the pneumatic main line 12 such that no compressed air is conducted through the pneumatic main line 12 in the filling direction B (cf FIG. 3A). Moreover, in the first operating mode B1 shown, in accordance with FIG. 3B, the venting valve 23.1 is shown in an energized state in which it unblocks the venting line 13 so that air can flow through it pneumatically.

The compressed air 141 from the branch line 14 can thus be conducted in the return direction R into the pneumatic main line 12 as compressed air 141 for regenerating the air dryer 5. The pressure of the compressed air 141 is preferably relieved via the throttle 8. The pressure-relieved compressed air 141′then flows through the air dryer 5 in the return direction R and binds a portion of the moisture adsorbed by the air dryer 5. The compressed air 131, which is moist as a result of the regeneration of the air dryer 5, is then discharged in the venting direction E via the venting line 13 and the venting port 3.

In FIG. 3C, the compressed-air supply unit 100 is shown in sleep mode I. In sleep mode I, the first pneumatic branch-line switching valve 24 blocks the branch line 14, the main-line switching valve 25 blocks the pneumatic main line 12, and the venting valve 23.1 blocks the venting line 13. The pneumatic branch-line switching valves 23.1, 24, 25 are preferably configured as 2/2-way valves which are closed when de-energized such that, in the de-energized state, as shown in FIG. 3A, they block the respective pneumatic lines 12, 13, 14 and the compressed-air supply unit 100 is in the de-energized state in the sleep mode I.

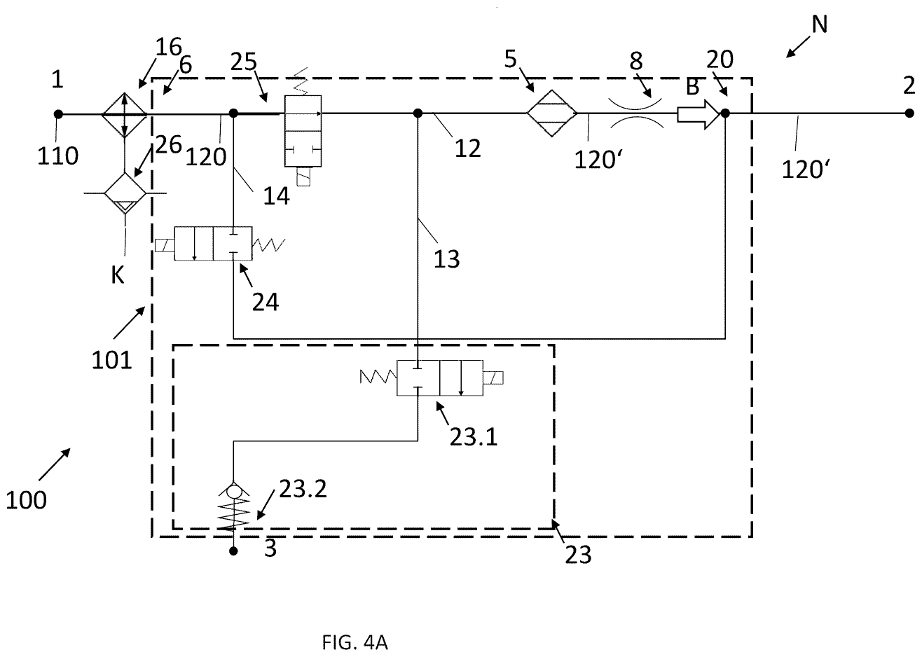

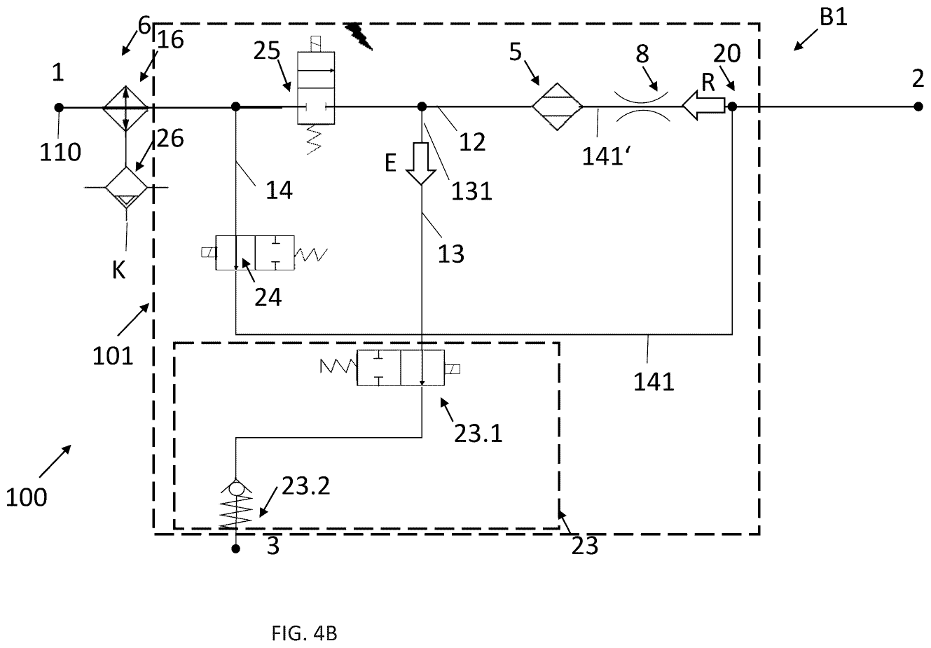

FIGS. 4A and 4B show a third embodiment of the compressed-air supply unit 100. In this document, the same or similar components have identical reference signs, as in the preceding embodiments of the compressed-air supply unit 100. In order to avoid repetition, reference is made to the above description of the compressed-air supply unit according to the first and second embodiments and only differences will be discussed below.

The third embodiment differs from the second embodiment only in the configuration of the main-line switching valve 25. The pneumatic main-line switching valve 25 according to the second embodiment was configured as a pneumatic branch-line switching valve which is closed when de-energized. In the unenergized state of this valve, the pneumatic main line 12 was thus blocked. The main-line switching valve 25 according to the third embodiment, on the other hand, is a switching valve which is open when de-energized. Thus, a permanent compressed-air supply is supplied at the compressed-air supply port 2, which supply is only interrupted when required for regeneration of the air dryer 5 in the first operating mode B1 (cf FIG. 4B).

The compressed-air supply unit 100 has the pressure control module 101 shown in FIG. 1. The first pneumatic branch-line switching valve 24, the main-line switching valve 25, and the venting valve 23.1 are associated with the pressure control module 101.

In the basic operating mode N, shown in FIG. 4A, of the compressed-air supply unit 100, the main-line switching valve 25 is shown in the unenergized state and air can flow pneumatically through the pneumatic main line 12 in the filling direction B. The first pneumatic branch-line switching valve 24 and the venting valve 23.1 are, on the other hand, also furthermore configured as branch-line switching valves which are closed when de-energized such that they block the branch line 14 and the venting line 13 in their unenergized state in the basic operating mode N shown.

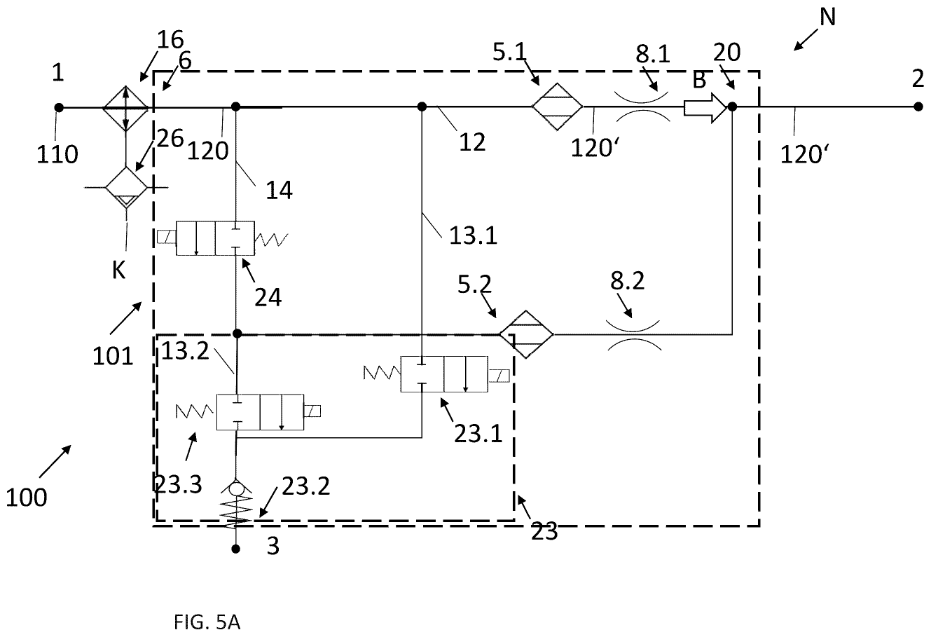

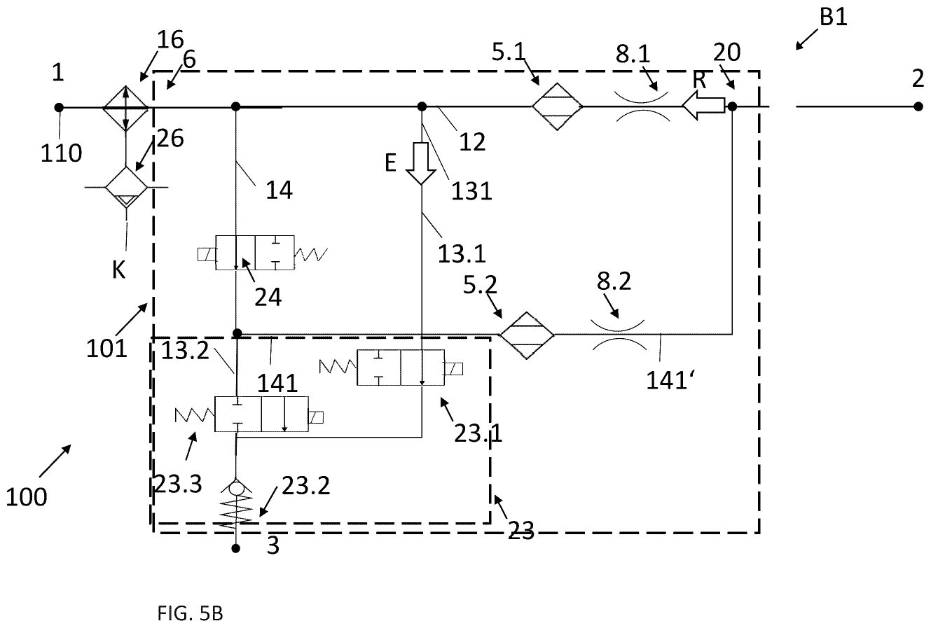

FIG. 5A and FIG. 5B show the compressed-air supply unit 100 according to a fourth embodiment. In this document, the same or similar components have identical reference signs and, in order to avoid repetition, reference is made to the description of the first to third embodiments of the compressed-air supply unit and only differences from the preceding embodiments will be discussed.

The fourth embodiment differs from the first embodiment shown in FIGS. 2A and 2B in that the air dryer 5.1 is a first air dryer and the throttle 8.1 is a first throttle, which are arranged in the pneumatic main line 12 and the compressed-air supply unit 100 moreover has a second air dryer 5.2 and moreover a second throttle 8.2 is arranged between the second air dryer 5.2 and the compressed-air supply port 2.

Furthermore, the venting line 13.1 is a first venting line and the venting valve 23.1 is a first venting valve arranged in the first venting line 13.1. The first venting line 13.1 departs from the pneumatic main line 12 between the water separator 6 and the first air dryer 5.1. The compressed-air supply unit 100 moreover includes a second venting line 13.2 in which a second venting valve 23.3 is arranged. The second venting line 13.2 departs from the branch line 14 between the branch-line switching valve 24 and the second air dryer 5.2. The venting check valve 23.2 is connected downstream of the first and second venting valves 23.1, 23.3 in the direction of the venting port 3.

The compressed-air supply unit 100 has the pressure control module 101 shown in FIG. 1. The first pneumatic branch-line switching valve 24 as well as the first venting valve 23.1 and the second venting valve 23.3 are associated with the pressure control module 101.

In FIG. 5A, the compressed-air supply unit 100 is shown in the basic operating mode N, in which the compressed air 120 partially dehumidified by the water separator 6 is conducted via the pneumatic main line 12 to the first air dryer 5.1, is dried by the latter, and is then restricted by the first throttle 8.1 in order to be conducted onward in the filling direction B as dried compressed air 120′. In the basic operating mode N shown, the branch line 14 is blocked by the pneumatic branch-line switching valve 24. Moreover, the first venting line 13.1 is also blocked by the first venting valve 23.1 and the second venting line 13.2 is blocked by the second venting valve 23.3 in the form of a 2/2-way solenoid directional control valve 31 (cf FIG. 12).

The compressed-air supply unit 100 moreover has in the fourth embodiment shown a pneumatic assembly 20 associated with the compressed-air supply port 2. The pneumatic assembly 20 is preferably configured to cooperate with the first pneumatic branch-line switching valve 24.

In the basic operating mode N shown in FIG. 5A, the pneumatic assembly 20 is preferably configured to allow the feeding of the dried compressed air 120′in the filling direction B toward the compressed-air supply port 2.

FIG. 5B shows the compressed-air supply unit 100 in the first operating mode B1. In the first operating mode B1, the first pneumatic branch-line switching valve 24 is configured to open the branch line 14 so that air can flow through it pneumatically in the direction of the compressed-air supply port 2 such that compressed air 110 is pre-dried by the water separator 6, flows as pre-dried compressed air 141 via the branch line 14 and the second air dryer 5.2 and the second throttle 8.2, and can be conducted as dried compressed air 141′ in the direction of the compressed-air supply port 2, preferably via the pneumatic assembly 20. The pneumatic assembly 20 is preferably configured to allow compressed air 141′ to return from the branch line 14 into the pneumatic main line 12 in the return direction R in the first operating mode B1 shown. The returned compressed air 141′ initially flows through the first throttle 8.1 and its pressure is relieved therein. The compressed air 141′ is then conducted in the return direction R through the first air dryer 5.1, as a result of which the first air dryer 5.1 is regenerated. The moist compressed air 131 reissuing from the first air dryer 5.1 is then conducted via the first venting line 13.1 and the opened first venting valve 23.1 in the direction of the venting port 3. By virtue of the pressure in the first venting line 13.1, the venting check valve 23.2 opens in a known manner and unblocks the first venting line 13.1.

The pneumatic assembly 20 is preferably also configured to allow dried compressed air 120′ to return from the pneumatic main line 12 into the branch line 14 in order to regenerate the second air dryer 5.2. The compressed air used for regenerating the second air dryer 5.2 can preferably be directed via the second venting line 13.2 and the second venting valve 23.2 toward the venting port 3.

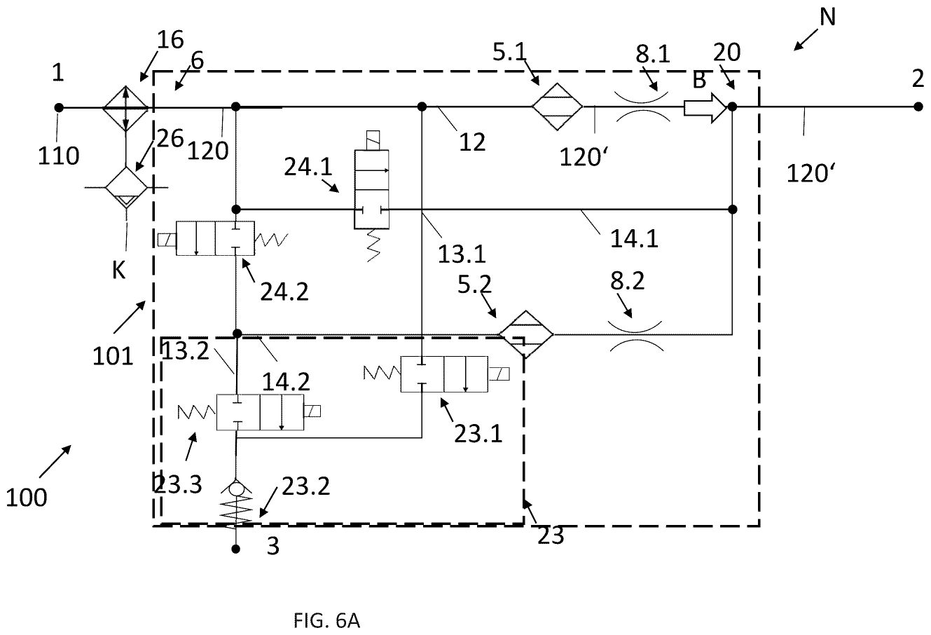

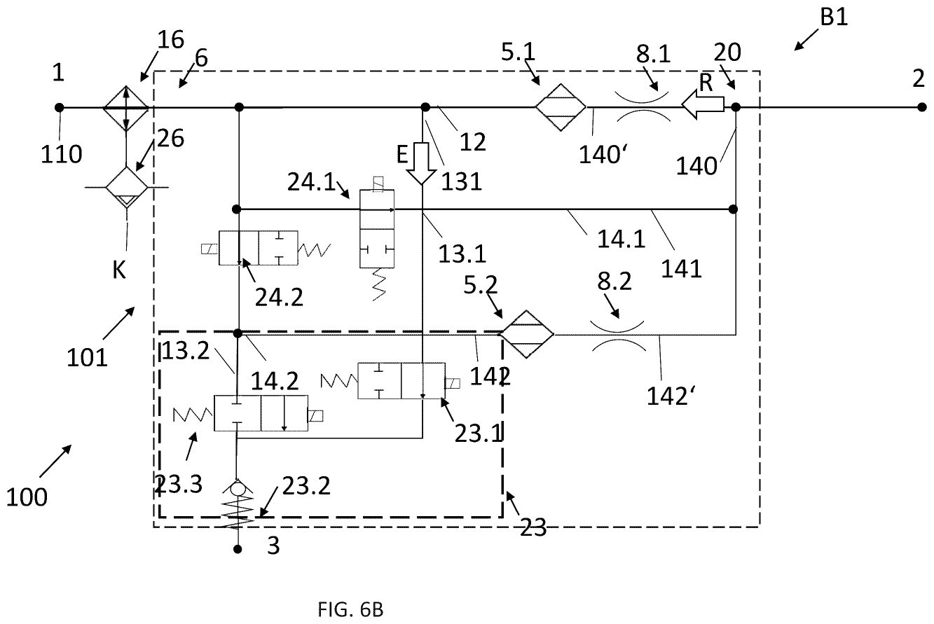

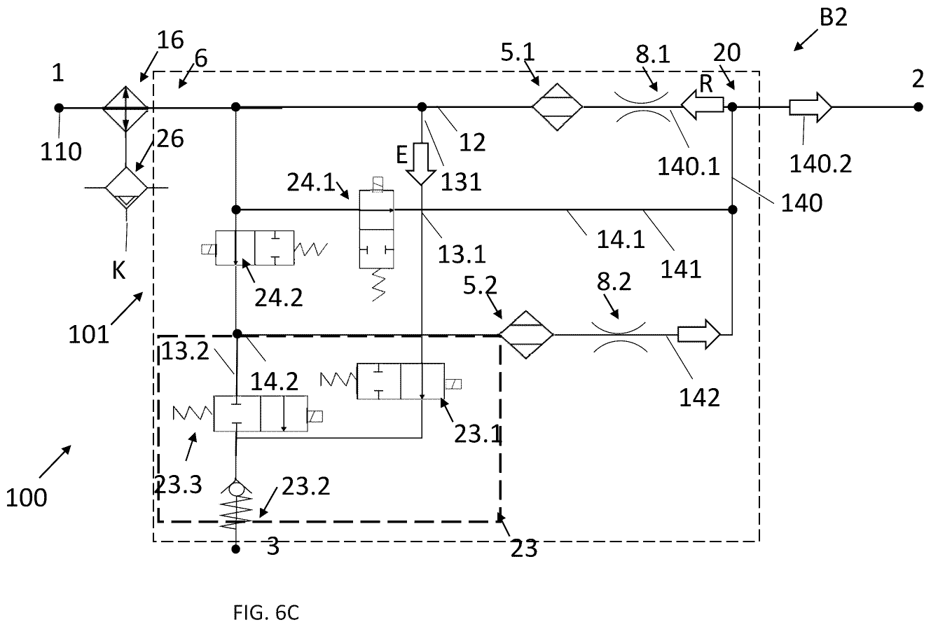

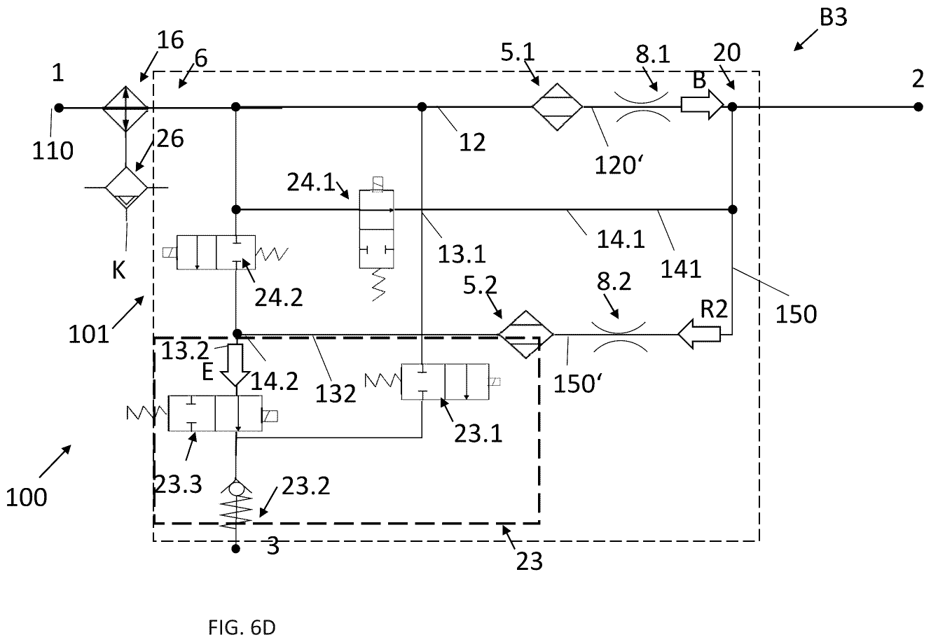

FIGS. 6A to 6D show a fifth embodiment of the compressed-air supply unit 100. In this document, the same or similar components have identical reference signs and, in order to avoid repetition, reference is made to the description of the first to third embodiments of the compressed-air supply unit and only differences from the preceding embodiments will be discussed.

The compressed-air supply unit 100 according to the fifth embodiment differs from the fourth embodiment shown above in FIGS. 5A and 5B in that the branch line 14.1 is a first branch line with a first pneumatic branch-line switching valve 24.1. The compressed-air supply unit 100 moreover includes a second branch line 14.2 with a second pneumatic branch-line switching valve 24.2 in the form of a 2/2-way solenoid directional control valve 31 (cf FIG. 12). The second air dryer 5.2 and the second throttle 8.2 are arranged in the second branch line 14.2. The second branch line 14.2 also departs from the pneumatic main line 12 between the water separator 6 and the first air dryer 5.1.

A second venting line 13.2 departs from the second branch line 14.2 between the second pneumatic branch-line switching valve 24.2 and the second air dryer 5.2. A second venting valve 23.3 is arranged in the second venting line 13.2. A venting check valve 23.2 is arranged, in a known manner, downstream of the first venting valve 23.1 and the second venting valve 23.3 in the direction of the venting port 3.

The compressed-air supply unit 100 has the pressure control module 101 shown in FIG. 1. The first pneumatic branch-line switching valve 24.1, the second pneumatic branch-line switching valve 24.2, as well as the first venting valve 23.1 and the second venting valve 23.3, are associated with the pressure control module 101.

In FIG. 6A, the compressed-air supply unit 100 is shown in the basic operating mode N, in which partially dehumidified compressed air 120 is supplied from the water separator 6 via the pneumatic main line 12 to the first air dryer 5.1, is dried therein, and is then restricted via the first throttle 8.1. The dried compressed air 120′ is conducted to the pneumatic assembly 20 in the filling direction B. The pneumatic assembly 20 is configured to conduct the dried compressed air 120′ toward the compressed-air supply port 2 in the basic operating mode N.

FIG. 6B shows the compressed-air supply unit 100 in a first operating mode B1. In the first operating mode B1, the pneumatic assembly 20 is configured to direct the compressed air 141 into the pneumatic main line 12 from the first branch line 14.1 and the dried compressed air 142′ from the second branch line 14.2 counter to the filling direction B as a common compressed-air flow 140 in the return direction R. In the pneumatic main line, the pressure of the returned compressed air 140 is first relieved via the first throttle 8.1 and has a reduced relative humidity as the pressure-relieved compressed air 140′. The pressure-relieved compressed air 140′ of the common compressed-air flow is then fed to the first air dryer 5.1 for regeneration. The moist compressed air 131 reissuing from the first air dryer 5.1 is then conducted via the first venting line 13.1 and the first venting valve 23.1 as well as the venting check valve 23.2 in the venting direction E in order to conduct compressed air to the venting port 3, and is discharged from the latter.

A second operating mode B2 is shown in FIG. 6C. The second operating mode B2 of the compressed-air supply unit 100 differs from the first operating mode B1 (cf FIG. 6B) in that the pneumatic assembly 20 is configured in the second operating mode B2 to return a first portion 140.1 of the common compressed-air flow 140 into the pneumatic main line 12 in the return direction R and to supply a second portion 140.2 at the compressed-air supply port 2. The pneumatic assembly 20 thus simultaneously enables in the second operating mode regeneration of the first air dryer 5.1 and supply of a compressed-air consumer, such as for example a sensor cleaning device (cf FIGS. 9, 10, and 11), with compressed air at the compressed-air supply port 2. The pneumatic assembly 20 is moreover configured to allow return of compressed air counter to the filling direction B through the second branch line 14.2.

FIG. 6D shows the compressed-air supply unit 100 in a third operating mode B3. In the third operating mode B3, the pneumatic assembly 20 is configured to return compressed air 120′ from the pneumatic main line 12 and compressed air 141 from the first branch line 14.1 as a common compressed-air flow 150 into the second branch line 14.2 in a return direction R. The pressure of the compressed air 150 returned in the second branch line 14.2 is relieved by the second throttle 8.2 and the compressed air flows through the second air dryer 5.2 as pressure-relieved compressed air 150′ in the return direction R. As already described with reference to the fourth embodiment (cf FIG. 5A and FIG. 5B), the moist compressed air 132 used for the regeneration of the second air dryer can be directed via the second venting line 13.2 to the venting port 3.

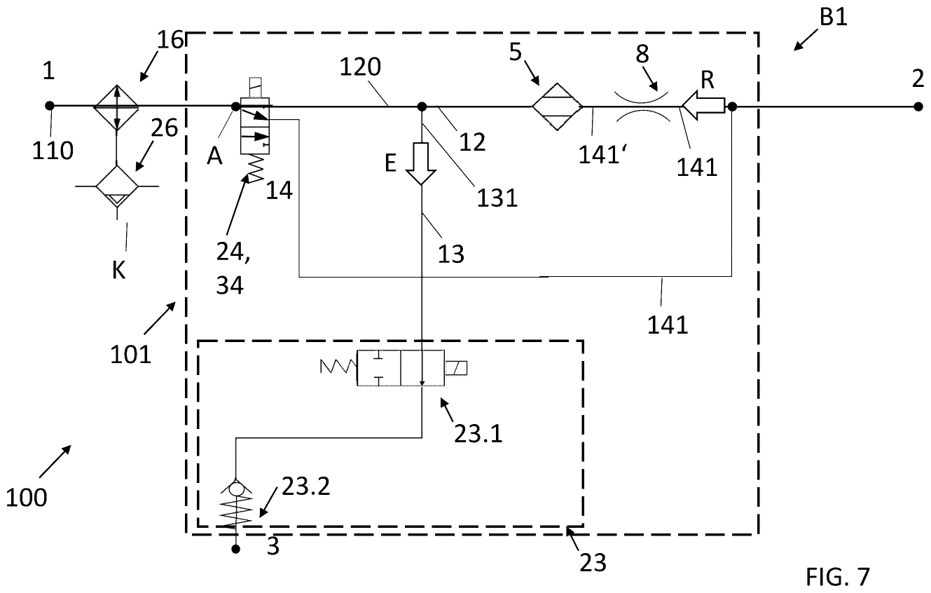

FIG. 7 shows a sixth embodiment of the compressed-air supply unit 100. In this document, the same or similar components have identical reference signs and, in order to avoid repetition, reference is made to the description of the first to third embodiments of the compressed-air supply unit and only differences from the preceding embodiments will be discussed.

The compressed-air supply unit 100 according to the sixth embodiment differs from the embodiment shown above in FIG. 2B in that the branch-line switching valve 24 is arranged at a branching point A. At the branching point A, the branch line 14 branches off from the pneumatic main line 12. The branch-line switching valve 24 is moreover configured as a 3/2-way valve 34. In the first operating mode B1 shown in FIG. 7, the 3/2-way valve 34 is configured to connect the branch line 14 to the compressed-air port 1 such that the compressed air 110 supplied at the compressed-air port 1 can be conducted through the branch line and can be conducted through the pneumatic main line 12 counter to the filling direction B for the regeneration of the air dryer 5. In the basic operating mode (not shown), the 3/2-way valve 34 is configured to connect the pneumatic main line 12 to the compressed-air port 1 such that the compressed air 110 supplied at the compressed-air port 1 can be conducted through the pneumatic main line 12 via the air dryer 5 to the compressed-air supply port 2 and be supplied there as dried compressed air.

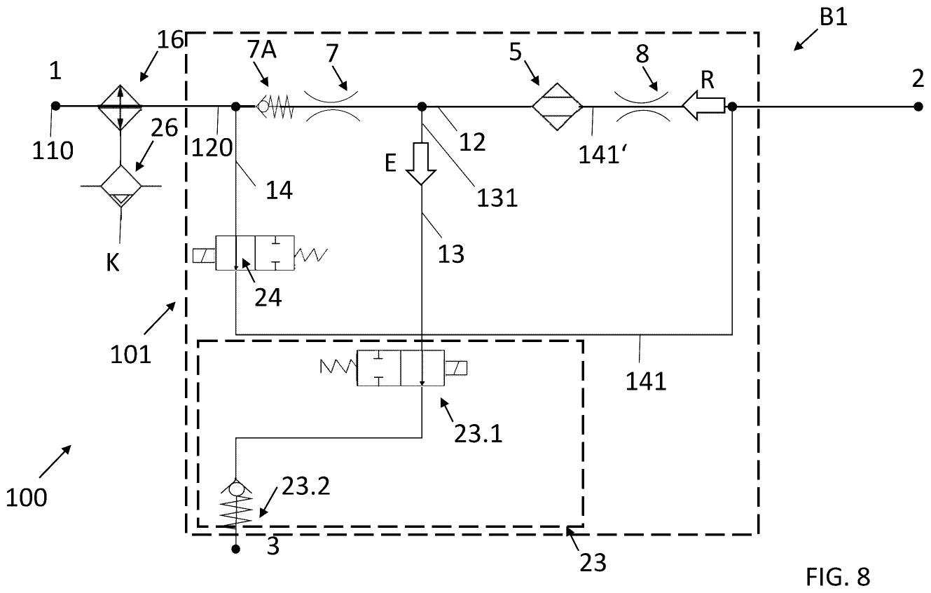

FIG. 8 shows a seventh embodiment of the compressed-air supply unit 100. In this document, the same or similar components have identical reference signs and, in order to avoid repetition, reference is made to the description of the first to third embodiments of the compressed-air supply unit and only differences from the preceding embodiments will be discussed.

The compressed-air supply unit 100 according to the seventh embodiment differs from the embodiment shown above in FIG. 2B in that arranged in the pneumatic main line 12 is a main-line throttle 7 which is configured to increase the flow resistance of the pneumatic main line 12 to a higher value than the flow resistance of the branch line 14. The compressed air 110 thus flows from the compressed-air port 1 in the first operating mode preferably through the branch line 14 owing to the lower flow resistance and consequently compressed air 141 passes predominantly through the branch line 14 and is conducted counter to the filling direction B through the pneumatic main line 12 for the regeneration of the air dryer 5.

A main-line check valve 7A is preferably connected upstream of the main-line throttle 7 in the filling direction B. The main-line check valve 7A arranged upstream of the main-line throttle 7 in the filling direction B is preferably configured to open at an opening pressure upstream of the main-line throttle 7 in the filling direction B which is higher than a pressure difference upstream and downstream of the main-line throttle 7. It should be understood that the main-line check valve 7A can also be used without the main-line throttle 7 and in this case is arranged downstream of the branching branch line 14 in the pneumatic main line 12.

FIG. 9 shows a vehicle 1000, in particular a car 1100. The car 1100 includes a compressed-air supply system 1200 as well as an electronic control unit 1300 (ECU) and a compressed-air consumer 300 which in the present case is a sensor cleaning device 301.

The compressed-air supply system 1200 includes a compressed-air supply unit 100 and a compressed-air generator 200 connected to the compressed-air supply unit 100 via a compressed-air port 1. In the present case, the compressed-air generator 200 includes a compressor 202 with an electric motor 203.

The compressed-air supply unit 100 is shown here in a sixth embodiment. The same or similar components have again identical reference signs as in the preceding embodiments, and in order to avoid repetition, only differences in particular with the first embodiment are discussed (cf. FIGS. 2A and 2B).

In the present case, the water separator 6 moreover includes, in addition to the condensation dryer 16 and the drain valve 26, a ventilation unit 36. The ventilation unit 36 is arranged between the compressed-air port 1 and the condensation dryer 16 and increases the degree of cooling of the pressurized air in the condensation dryer 16. The water separator 6 with the condensation dryer 16, the drain element 26, in particular a drain valve 26, and the ventilation unit 36 is preferably arranged in a front part 1400 of the vehicle 1000 in the direction of travel F. The wind from driving which occurs during operation can thus additionally be used to cool the compressed air compressed by the compressor 202.

Furthermore, the compressed-air supply unit 100 according to the sixth embodiment shown includes a pressure sensor 9 which is arranged in the pneumatic main line 12 between the water separator 6 and the air dryer 5. The pressure sensor 9 is configured to detect a pressure P in the pneumatic main line 12, that is, the input pressure, supplied at the compressed-air port 1, of the moist compressed air 110 or the compressed air 120 partially dehumidified by the water separator. The pressure sensor 9 is connected by signals to the control device 1300 via a first signal line S1 and is thus configured for monitoring the pressure P.

The control device 1300 is moreover connected via a second signal line S2 by control technology to the branch-line switching valve 24 and via a third signal line S3 by control technology to the venting valve 23.1.

The control device 1300 is configured to actuate the branch-line switching valve 24 for selectively unblocking the branch line 14, or the venting valve 23.1 for selectively unblocking the venting line 13. Moreover, the control device 1300 is connected via a fourth signal line S4 to the pneumatic assembly 20, as described with reference to the fourth and fifth embodiments. The control device 1300 is configured to control the first portion of the compressed air 140.1 (cf FIG. 6C) and the second portion of the compressed air 140.2 (cf FIG. 6C) by actuating the pneumatic assembly 20.

The control device 1300 is configured to actuate the compressed-air generator 200 depending on the detected sensor signal of the pressure sensor 9. The control device 1300 can moreover actuate the main-line switching valve 25 and the venting valve 23.1 in order to release compressed air in the pneumatic main line—at least upstream of the throttle 8 in the filling direction B.

The signal lines S1, S2, S3, S4 can be wired or wireless.

The compressed-air supply unit 100 has the pressure control module 101 shown in FIG. 1. The pneumatic branch-line switching valve 24 and the venting valve 23.1 and the pressure sensor 9 are associated with the pressure control module 101.

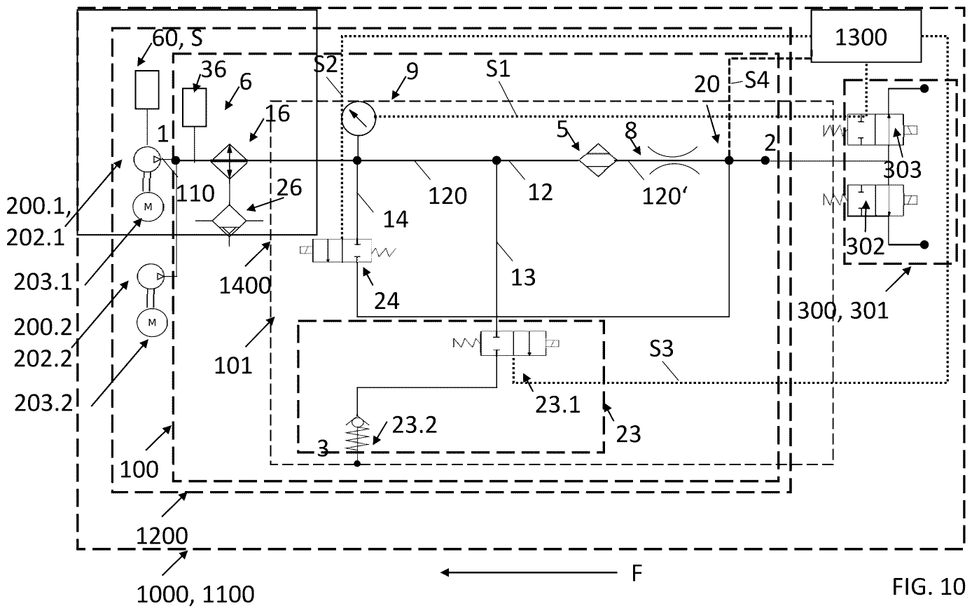

FIG. 10 shows a second embodiment of the vehicle 1000. In order to avoid repetition, reference is made to the description of the vehicle 1000 according to the first embodiment in FIG. 9 and only differences will be discussed. The same or similar components have identical reference signs in this document.

The second embodiment shown of the vehicle 1000 in accordance with FIG. 10 differs from the first embodiment in that, in addition to the compressed-air generator 200 which includes a first pressurizer 201.1 with a first electric motor 203.1, an additional compressed-air source 50 is moreover provided. The compressed-air source 50 includes a second pressurizer 201.2 with a second electric motor 203.2.

The control device 1300 is preferably configured, in addition to the operation of the compressed-air generator 200, to selectively connect the compressed-air source 50 to the pneumatic main line. Both the compressed-air generator 200 and the compressed-air source 50 are connected to the compressed-air port 1 for supplying the compressed-air supply unit 100 with compressed air 110.

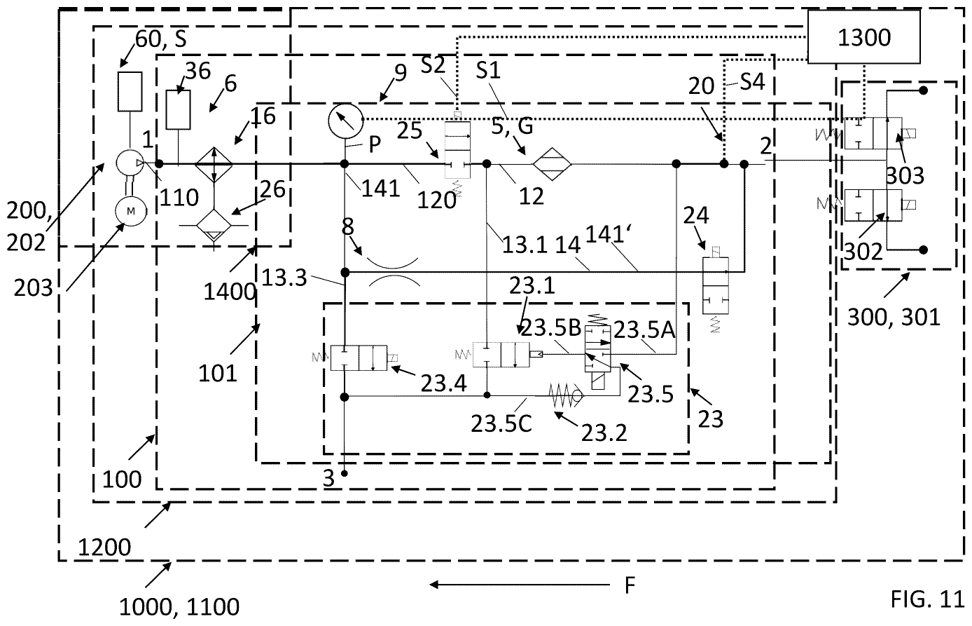

FIG. 11 shows a third embodiment of the vehicle 1000. In order to avoid repetition, reference is made to the description of the vehicle 1000 according to the first embodiment in FIG. 9 and only differences will be discussed. The same or similar components have identical reference signs in this document.

The third embodiment shown of the vehicle 1000 in accordance with FIG. 11 differs from the first embodiment in that the throttle 8 is now arranged in the branch line 14 upstream of the branch-line switching valve 24 instead of in the pneumatic main line 12. The throttle 8 relieves the pressure of the compressed air 141, conducted through the branch line 14, at the start of the branch line 14, as a result of which the pressure-relieved compressed air 141′ has a reduced relative humidity. The branch line 14 and the branch-line switching valve 24 arranged therein are thus protected against frost-related malfunctions. At the same time, in the case of the return of the compressed air 141 through the pneumatic main line 12 counter to the filling direction B, pressure relief necessary for the regeneration of the air dryer 5 is obtained by the throttle 8.

Furthermore, a main-line switching valve 25 is arranged in the pneumatic main line 12, as described with reference to FIG. 3A to FIG. 3C.

The venting valve assembly 23 has a control valve 23.5 in the form of a 2/2-way solenoid directional valve 31 (cf FIG. 12). The venting valve 23.1 is moreover configured as a pneumatically actuatable venting valve 23.1. The control valve 23.5 can be actuated via electrical control signals in the form of a voltage and/or current signal. When actuated, the control valve 23.5 can be transferred from a position in which it is closed when de-energized into a pneumatically open position (not shown) in which a pressure derived from the pneumatic main line 12 via a pneumatic control line 23.5A is transmitted via a bypass 23.5B for pneumatically controlling the controllable venting valve 23.1.

When closed, the control valve 23.5 disconnects the control line 23.5A and is pneumatically connected to the venting port 3 via a further pneumatic line 23.5C.

The venting line 13.1 is in the present case a first venting line 13.1 and the compressed-air supply unit 100 moreover includes a compressor venting line 13.3. The compressor venting line 13.3 departs from the pneumatic main line 12 upstream of the main-line switching valve 25 in the filling direction B. The venting valve assembly 23 has a compressor venting valve 23.4 in the compressor venting line 13.3. The line volume between the compressed-air generator 200, in the present case preferably a compressor 202, and the branch-line switching valve 24 and the main-line switching valve 25 can be vented through the compressor venting line 13.3. The starting resistance for the compressor 202 is thus reduced.

The venting valve 23.1, the compressor venting valve 23.4, and the branch-line switching valve 24 and the main-line switching valve 25 are in the present case configured as solenoid directional control valves 31 (cf FIG. 12), in particular solenoid directional control valves which are closed when de-energized.

The compressed-air supply system 1200 in the embodiments in accordance with FIGS. 9, 8 and 9 preferably moreover includes a temperature sensor 60 for monitoring the temperature of the compressed-air generator 200, wherein the temperature sensor 60 is connected to the control device 1300 by signals and is configured to supply sensor signals S.

The compressed-air consumer 300 which in the present case is a sensor cleaning device 301 moreover has a first nozzle valve 302 and a second nozzle valve 303. The nozzle valves 302, 303 are also solenoid directional control valves 31 (cf FIG. 12), in particular solenoid directional control valves which are closed when de-energized.

Such a solenoid directional control valve 31 is shown by way of example in FIG. 12 on the basis of a possible configuration of a nozzle valve 302. The nozzle valve 302 is a 2/2-way valve 304 which is closed when de-energized. The nozzle valve 302 includes a magnetic part 305 and a pneumatic part 306. The magnetic part 305 has an electric coil 307, an armature 308.1 which is actuatable magnetically and under the influence of a spring force, and a fixed magnetizable core 308.2. An air gap 309 which defines the possible stroke of the armature 308.1 is formed between the armature 308.1 and the core 308.2.

The pneumatic part 306 includes a first compressed-air passage 310 and a second compressed-air passage 311. The pneumatic part 306 moreover includes a valve stem part 312 which has an abutment surface 313 facing in the direction of the armature 308.1.

The nozzle valve 302 moreover includes a valve spring 314 which is configured to apply a spring force F_{F} to the armature 308.1 in the direction of the valve stem part 312, in particular the abutment surface 313. When the nozzle valve 302 is open, the armature 308.1 is spaced apart from a valve seat 315 of the pneumatic part 306.

The armature 308.1 is held movably in the magnetic part 305 and the pneumatic part 306. By energizing the electric coil 307, the latter generates a magnetic field with a magnetic force F_{M}. The resulting magnetic field generates a magnetic pole at the core 308.2, which attracts the armature 308.1 and moves it away from the valve seat 315 counter to the spring force F_{F} of the valve spring 314 such that the first compressed-air passage 310 and the second compressed-air passage 311 are fluidically connected. The magnitude of the magnetic force F_{M} depends on the applied control current S_{I} which is supplied by the control device 1300. The opening control current S_{I1} necessary to open the nozzle valve 302 is greater than the holding control current S_{I2} necessary to hold the nozzle valve 302 in the open position. The magnitude of the force which a magnetic field induced by the coil 307 applies to the armature 308.1 at a constant current depends on the distance of the armature 308.1 relative to the magnetic field, that is, the size of the air gap 309 between the armature 308.1 and the core 308.2. A weaker magnetic field thus acts in the case of a larger distance. In the closed position, the armature 308.1 first has a greater distance from the magnetic field such that an increased current, namely an opening control current S_{I1} is supplied. The opening control current S_{I1} necessary to open the nozzle valve 302 refers to the current which is necessary to reduce the distance of the armature 308.1 from the core 308.2, and thus the air gap 309. As soon as the armature 308.1 moves into an open position, its distance from the magnetic field is reduced and a lower holding control current S_{I2} is sufficient to hold the armature 308.1 in this position. The control device 1300 is moreover preferably configured to apply a heating control current S_{I3} to the nozzle valve 302 which is smaller than the opening control current S_{I1}, in particular also smaller than the holding control current S_{I2}, such that that the nozzle valve 302 is heated by the generated magnetic field in the closed state.

The control device 1300 shown in FIG. 9 to FIG. 11 is configured to supply a control current S_{I} of the same magnitude as the opening control current S_{I1} (cf FIG. 12) in order to open the compressor venting valve 23.4 and the branch-line switching valve 24, the main line switching valve 25, and the nozzle valves 302, 303. The control device 1300 is in addition configured to supply a control current S_{I} of the same magnitude as the holding control current S_{I2} (cf FIG. 12) in order to maintain the opening. The control device 1300 is moreover also configured to apply a heating control current S_{I3} to one, a plurality, or all of these valves. The heating control current S_{I3} is preferably 70% to 80% of the holding control current S_{I2}. The holding control current S_{I2} is moreover smaller than the opening control current S_{I1}.

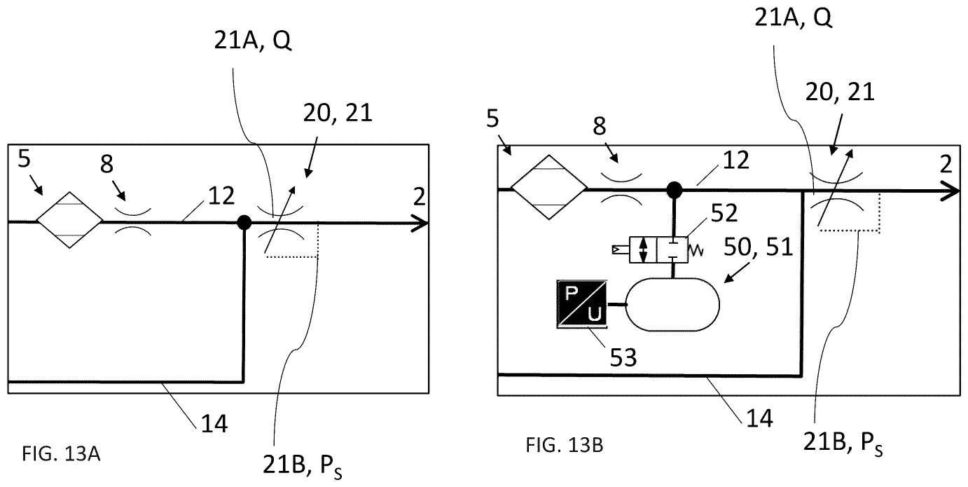

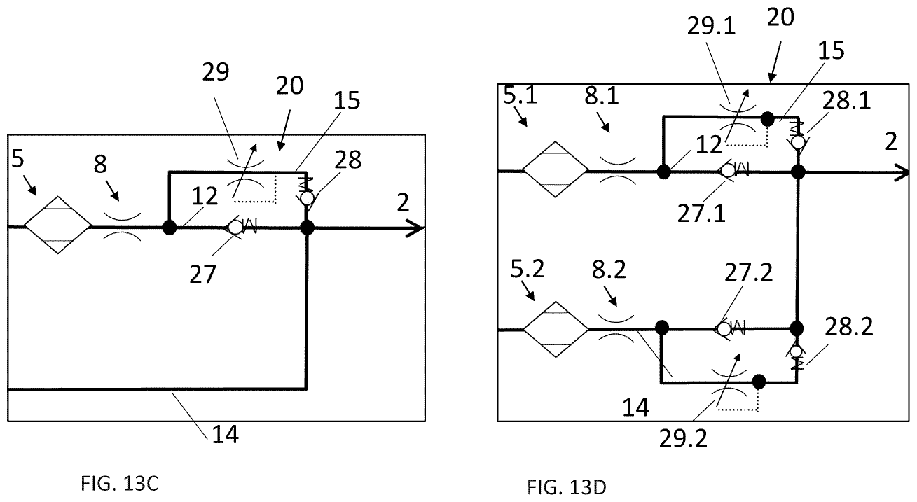

FIG. 13A to FIG. 13D show a detail of the compressed-air supply system 1200 in accordance with FIG. 9, FIG. 10, or FIG. 11, wherein different embodiments of the pneumatic assembly 20 are shown in detail. In order to avoid repetition and to explain the functioning of the pneumatic assembly 20, reference is therefore made to the description of FIG. 9, FIG. 10, and FIG. 11.

The pneumatic assembly 20 in accordance with FIG. 13A includes a throttle valve 21 which is configured to restrict compressed air conducted to the compressed-air supply port 2 in the filling direction B. The throttle valve 21 has a variable flow cross section Q and is connected to the control device 1300 by control technology, that is, by signals. The throttle valve 21 is configured to restrict the pressure in the pneumatic main line 12 downstream of the throttle valve 21 to a supply pressure to be supplied of in particular 5 bar by changing the flow cross section Q. Upstream of the throttle valve 21, a pressure is set according to the volume flow conditions. The throttle valve 21 has a throttle point 21A with a variable flow cross section Q, wherein the throttle valve 21 has a control pressure line 21B for conducting a control pressure P_{S} and is configured to regulate the flow cross section Q depending on the control pressure P_{S}.

The pneumatic assembly 20 in accordance with FIG. 13B includes, in a similar fashion to the embodiment shown in FIG. 13A, a controllable throttle valve 21. The compressed-air supply system 1200 furthermore includes an additional compressed-air source 50 in addition to the compressed-air generator 200 which is configured as a compressor 202 in FIG. 9. The compressed-air source 50 includes a reservoir 51 for storing compressed air, wherein the reservoir 51 is connected to the pneumatic main line 12 upstream of the throttle 21 via a reservoir switching valve 52. The compressed-air source 50 is configured to be connected to the pneumatic main line 12 as required by actuating the reservoir switching valve 52. The control device 1300 (cf FIGS. 9, 8 or 9) is connected to a reservoir pressure sensor 53 by signals and is configured to actuate the reservoir switching valve 52. By actuating the reservoir switching valve 52, a defined amount of compressed air can be directed into the pneumatic main line 12, wherein the control device 1300 regulates the amount of compressed air via the signals of the reservoir pressure sensor 53 and preferably the reservoir switching valve 52.

The pneumatic assembly 20 in accordance with FIG. 13C includes a pair of check valves 27, 28 which open in opposite directions and are fluidically connected in parallel and which are arranged between the air dryer 5 and the compressed-air supply port 2.

The pair of check valves 27, 28 includes a first check valve 27 opening in the filling direction B and which is arranged in the pneumatic main line 12, and moreover a second check valve 28 opening in the return direction R. The second check valve 28 is arranged in a bypass line 15 which forms a bypass around the first check valve 27. The pneumatic assembly 20 moreover includes a return throttle valve 29 arranged downstream of the second check valve 28 in the return direction R.

The pneumatic assembly 20 in accordance with FIG. 13D is configured for use with compressed-air supply units such as those shown in FIGS. 5A-5B and 6A-6D, that is, for compressed-air supply units with two air dryers 5.1, 5.2. A first pair of check valves 27.1, 28.1 which open in opposite directions and are fluidically connected in parallel, with a corresponding return throttle valve 29.1, as have been described with reference to the embodiment in accordance with FIG. 13C, are associated with the first air dryer 5.1 and arranged between the first air dryer 5.1 and the compressed-air port 2.

A second pair of check valves 27.2, 28.2 which open in opposite directions and are fluidically connected in parallel, with a corresponding second return throttle valve 29.2, as have been described with reference to the embodiment in accordance with FIG. 13C, are associated with the second air dryer 5.2 and arranged between the second air dryer 5.2 and the compressed-air port 2.

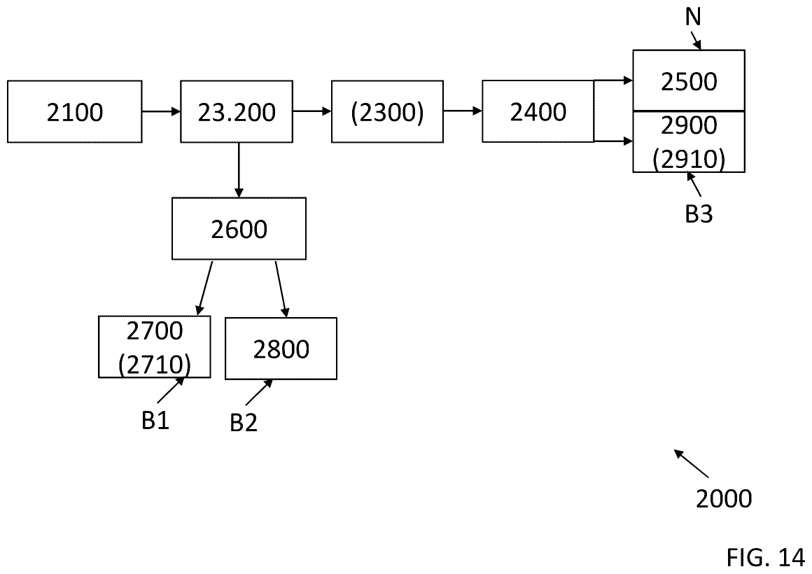

FIG. 14 shows a method 2000 for operating a compressed-air supply system 1200 (cf FIGS. 9, 8 and 9), wherein the method 2000 in a first step includes the supply 2100 of compressed air 110 at a compressed-air port 1. The compressed-air port 1 is connected to a compressed-air supply port 2 via a pneumatic main line 12. In a second step 2200, the method includes the separation of water from the compressed air 110 supplied at the compressed-air port 1 (cf FIG. 2A to FIG. 13) for supplying dehumidified compressed air 120. In a basic operating mode N, the method 2000 preferably includes in a third step 2300 the blocking of a branch line 14, 14.1 (cf FIG. 2A to FIG. 11) and moreover, in a fourth step 2400, the drying of the dehumidified compressed air 120 conducted in a filling direction B to the compressed-air supply port 2 with an air dryer 5 arranged in the pneumatic main line 12. The method 2000 furthermore includes, in the basic operating mode N, the supply of the dried compressed air 120′at the compressed-air supply port 2 in step 2500.

The method moreover includes in a first operating mode, following the second step 2200, in a sixth step 2600 the opening of a branch line 14 pneumatically so that air can flow through it pneumatically in the direction of the compressed-air supply port 2 through a pneumatic branch-line switching valve 24, and moreover in a seventh step 2700 the return of dehumidified compressed air from the branch line 14 through the pneumatic main line 12 counter to the filling direction B. The seventh step 2700 preferably moreover includes as the part step 2710 the pressure relief of compressed air, returned counter to the filling direction B, in the pneumatic main line 12.

In the second operating mode B2, the method 2000 moreover includes, following the sixth step 2600, in an eighth step 2800 the distribution of compressed air 140 from the branch line 14, 14.1, 14.2 such that a first portion 140.1 of the compressed air is returned into the pneumatic main line 12 counter to the filling direction B and moreover a second portion 140.2 of the compressed air is supplied at the compressed-air supply port 2. This preferably includes receiving control signals and controlling the first portion and the second portion depending on the received control signals via a pneumatic assembly.

In the third operating mode B3, the method 2000 includes, compared with operation in the basic operating mode N, following the second step 2200, return of compressed air into the branch line 14, 14.2 in a return direction R in step 2900 and pressure relief of returned compressed air in the branch line through a second throttle 8.2 in step 2910.

In the context of the disclosure, it should be understood that the first operating mode B1 relates to a first regeneration mode for the regeneration of the (first) air dryer. The second operating mode B2 relates to a distribution mode in which a part of the compressed air is used for the regeneration of the first air dryer and the remaining part of the compressed air partially dehumidified by the water separator 6 or a second air dryer 5.2 is conveyed to the compressed-air supply port 2. The third operating mode B3 relates to a second regeneration mode for the regeneration of the second air dryer. The sleep mode I relates to an operating mode in which the air dryer 5, 5.1, 5.2 is pneumatically decoupled. In the basic operating mode N, compressed air dried by the (first) air dryer 5, 5.1 is conveyed to the compressed-air supply port 2.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 compressed-air port
2 compressed-air supply port
3 venting port
5 air dryer
5.1 first air dryer
5.2 second air dryer
6 water separator
7 main-line throttle
7A main-line check valve
8 throttle
8.1 first throttle
8.2 second throttle
9 pressure sensor
12 pneumatic main line
13 venting line
13.1 first venting line
13.2 second venting line
13.3 compressor venting line
14 branch line
14.1 first branch line
14.2 second branch line
15 bypass line
16 condensation dryer
20 pneumatic assembly
21 throttle valve in the pneumatic main line
21A throttle point
21B control pressure line
23 venting valve assembly
23.1 first venting valve
23.2 venting check valve
23.3 second venting valve
23.4 compressor venting valve
23.5 control valve
23.5A control line
23.5B bypass
23.5C line
24 branch-line switching valve
24.1 first branch-line switching valve in the branch line
24.2 second branch-line switching valve in the branch line
25 pneumatic main-line switching valve
26 drain element
27, 27.1, 27.2 first check valve
28, 28.1, 28.2 second check valve
29, 29.1, 29.2 return throttle valve
31 solenoid directional control valve
34 3/2-way valve
36 ventilation unit
50 compressed-air source
51 reservoir
52 reservoir switching valve
53 reservoir pressure sensor
60 temperature sensor
100 compressed-air supply unit
101 pressure control module
110 compressed air at the compressed-air port
120 partially dehumidified compressed air in the pneumatic main line
120′ dried compressed air in the pneumatic main line
131 moist compressed air in the (first) venting line
132 moist compressed air in the second venting line
140 returned compressed-air flow from the first and second branch line
140′ pressure-relieved compressed-air flow from the first and second branch line
140.1 first portion of compressed air, returned compressed air in the pneumatic main line
140.2 second portion of compressed air
141 compressed air in/out of the first branch line
141′ pressure-relieved compressed air in/out of the first branch line
142 compressed air in the second branch line
142′ dried compressed air in/out of the second branch line
150 returned compressed-air flow from the first branch line and the pneumatic main line
150′ pressure-relieved compressed-air flow from the first branch line and the pneumatic main line
200 compressed-air generator
201 pressurizer
201.1 first pressurizer
201.2 second pressurizer
202 compressor
203 electric motor
203.1 first electric motor
203.2 second electric motor
300 compressed-air consumer
301 sensor cleaning device
302 first nozzle valve
303 second nozzle valves
304 2/2-way valve
305 magnetic part
306 pneumatic part
307 coil
308 armature
309 air gap
310 first compressed-air passage
311 second compressed-air passage
312 valve stem part
313 abutment surface
314 valve spring
315 valve seat
1000 vehicle
1100 car
1200 compressed-air supply system
1300 control unit
1400 front region of the vehicle
2000 method
2100 supply of compressed air
2200 separation of water
2300 blocking of the branch line
2400 drying of compressed air in the pneumatic main line
2500 supply of dry compressed air at the compressed-air supply port
2600 opening of a branch line
2700 return of dehumidified compressed air into the pneumatic main line
2710 pressure relief of returned compressed air in the pneumatic main line
2800 distribution of compressed air
2900 return of compressed air into the branch line
2910 pressure relief of returned compressed air in the branch line
S1 first signal line
S2 second signal line
S3 third signal line
S4 fourth signal line
S sensor signals
F direction of travel
B filling direction
R return direction
E venting direction
B1 first operating mode
B2 second operating mode
B3 third operating mode
I sleep mode
N basic operating mode
K condensate
P pressure in the pneumatic main line
G degree of saturation
F_{F} spring force
F_{M} magnetic force
S_{I} control current
S_{I1} opening control current
S_{I2} holding control current
S_{I3} heating control current
P_{S} control pressure
Q flow cross section
A branching point
S_{W} flow resistance

1. A compressed-air supply unit for a sensor cleaning device of a vehicle, the compressed-air supply unit comprising:
a compressed-air port for connection to a compressed-air generator;
a compressed-air supply port for connecting a compressed-air consumer;
a pneumatic main line for conducting compressed air from said compressed-air port to said compressed-air supply port in a filling direction;
an air dryer arranged in said pneumatic main line for drying the compressed air conducted in the filling direction;
a throttle associated with said air dryer;
a water separator arranged in said pneumatic main line between said compressed-air port and said air dryer;
a branch line departing from said pneumatic main line between said water separator and said air dryer and reconnecting between said air dryer and said compressed-air supply port;
said branch line having a pneumatic branch-line switching valve configured, in a first operating mode, to open said branch line in a direction of said compressed-air supply port so that air can flow through said branch line pneumatically; and,
wherein the compressed-air supply unit is configured, in said first operating mode, to allow return of the compressed air from said branch line through said throttle counter to the filling direction.

2. The compressed-air supply unit of claim 1, wherein said pneumatic branch-line switching valve is configured to block said branch line in a basic operating mode.

3. The compressed-air supply unit of claim 1, wherein said water separator has a condensation dryer and a drain element for draining condensate.

4. The compressed-air supply unit of claim 1 further comprising an external ventilation unit associated with said pneumatic main line and arranged upstream of at least one of said water separator and a drain element of said water separator in the filling direction.

5. The compressed-air supply unit of claim 1, wherein said air dryer is a first air dryer, the compressed-air supply unit further comprising a second air dryer arranged in said branch line.

6. The compressed-air supply unit of claim 1, wherein said branch line is a first branch line, and said air dryer is a first air dryer, the compressed-air supply unit further comprising:
a second branch line departing from said pneumatic main line between said water separator and said first air dryer and rejoining between said first air dryer and said compressed-air supply port; and,
a second air dryer arranged in said second branch line.

7. The compressed-air supply unit of claim 6, wherein said pneumatic branch-line switching valve is a first pneumatic branch-line switching valve;
said second branch line has a second pneumatic branch-line switching valve configured, in said first operating mode, to open said second branch line so that air can flow through said second branch line pneumatically in the direction of said compressed-air supply port.

8. The compressed-air supply unit of claim 1, wherein at least one of:
a pneumatic main-line switching valve is arranged in said pneumatic main line upstream of said air dryer in the filling direction, said pneumatic main-line switching valve being configured, in said first operating mode, to block said pneumatic main line in the filling direction;
a main-line throttle is arranged in said pneumatic main line and is configured to increase a flow resistance of said pneumatic main line relative to said branch line; and,
said branch-line switching valve is arranged at a branching point at which said branch line branches off from said pneumatic main line and said branch-line switching valve is configured as a 3/2-way valve.

9. The compressed-air supply unit of claim 1 further comprising:
a pneumatic assembly associated with said compressed-air supply port and configured, in said first operating mode, to allow return of the compressed air from said branch line into said pneumatic main line counter to the filling direction.

10. The compressed-air supply unit of claim 9, wherein:
said pneumatic assembly in a second operating mode is configured to distribute the compressed air from said branch line such that a first portion of said compressed air is returned into said pneumatic main line counter to the filling direction and a second portion of said compressed air is supplied at said compressed-air supply port; and,
said pneumatic assembly is configured to be connected by control technology to an electronic control unit for adjusting said first portion and said second portion.

11. The compressed-air supply unit of claim 6, further comprising:
a pneumatic assembly associated with said compressed-air supply port and configured, in said first operating mode, to allow return of the compressed air from at least one of said first branch line and said second branch line into said pneumatic main line counter to the filling direction;
said pneumatic assembly in a second operating mode is configured to distribute the compressed air from at least one of said first branch line and said second branch line such that a first portion of said compressed air is returned into said pneumatic main line counter to the filling direction and a second portion of said compressed air is supplied at said compressed-air supply port; and,
said pneumatic assembly is configured to be connected by control technology to an electronic control unit for adjusting said first portion and said second portion; and,
said pneumatic assembly in a third operating mode is configured to allow return of the compressed air from at least one of said first branch line and the compressed air from said pneumatic main line into said second branch line counter to the filling direction.

12. The compressed-air supply unit of claim 1, wherein said throttle is arranged in said branch line upstream of said branch-line switching valve.

13. The compressed-air supply unit of claim 9, wherein:
said pneumatic assembly includes a controllable throttle valve configured to restrict the compressed air conducted to said compressed-air supply port in the filling direction;
said throttle valve has a throttle point with a variable flow cross section; and,
said throttle valve has a control pressure line for conducting a control pressure and is configured to regulate the flow cross section depending on the control pressure.

14. The compressed-air supply unit of claim 1, wherein the vehicle is a car.

15. The compressed-air supply unit of claim 1, wherein said compressed-air consumer is the sensor cleaning device.

16. A compressed-air supply system for a sensor cleaning device of a vehicle, the compressed-air supply system comprising:
a compressed-air supply unit having a compressed-air port;
a compressed-air generator for supplying compressed air at said compressed-air port;
said compressed-air supply unit being connected to said compressed-air generator via said compressed-air port, said compressed-air supply unit being for supplying compressed air for the sensor cleaning device;
said compressed-air supply unit further having a compressed-air supply port for connecting the sensor cleaning device and a pneumatic main line for conducting the compressed air from said compressed-air port to said compressed-air supply port in a filling direction;
said compressed-air supply unit including an air dryer arranged in said pneumatic main line for drying the compressed air conducted in the filling direction;
said compressed-air supply unit further including a throttle associated with said air dryer and a water separator arranged in said pneumatic main line between said compressed-air port and said air dryer;
said compressed-air supply unit further including a branch line departing from said pneumatic main line between said water separator and said air dryer and reconnecting between said air dryer and said compressed-air supply port;
said branch line having a pneumatic branch-line switching valve configured, in a first operating mode, to open said branch line in a direction of said compressed-air supply port so that air can flow through said branch line pneumatically; and,
said compressed-air supply unit being configured, in said first operating mode, to allow return of the compressed air from said branch line through said throttle counter to the filling direction.

17. The compressed-air supply system of claim 16 further comprising:
a pressure sensor arranged between said water separator and at least one of said air dryer and a main-line switching valve arranged upstream of said air dryer in the filling direction; and,
said pressure sensor being configured to detect a pressure in said pneumatic main line.

18. The compressed-air supply system of claim 16 further comprising:
a compressed-air source; and,
a control unit being configured to connect said compressed-air source to said pneumatic main line as required.

19. The compressed-air supply system of claim 16, wherein said compressed-air generator is a pressurizer.

20. A vehicle comprising:
a compressed-air consumer connected to a compressed-air supply port;
a compressed-air supply system for providing compressed air at said compressed-air supply port;
said compressed-air supply system including a compressed-air supply unit having a compressed-air port and a compressed-air generator for supplying the compressed air at said compressed-air port;
said compressed-air supply unit being connected to said compressed-air generator via said compressed-air port, said compressed-air supply unit being for supplying the compressed air for the compressed-air consumer;
said compressed-air supply unit further having a compressed-air supply port for connecting the compressed-air consumer and a pneumatic main line for conducting the compressed air from said compressed-air port to said compressed-air supply port in a filling direction;
said compressed-air supply unit including an air dryer arranged in said pneumatic main line for drying the compressed air conducted in the filling direction;
said compressed-air supply unit further including a throttle associated with said air dryer and a water separator arranged in said pneumatic main line between said compressed-air port and said air dryer;
said compressed-air supply unit further including a branch line departing from said pneumatic main line between said water separator and said air dryer and reconnecting between said air dryer and said compressed-air supply port;
said branch line having a pneumatic branch-line switching valve configured, in a first operating mode, to open said branch line in a direction of said compressed-air supply port so that air can flow through said branch line pneumatically;
said compressed-air supply unit being configured, in said first operating mode, to allow return of the compressed air from said branch line through said throttle counter to the filling direction;
an electronic control unit for controlling said compressed-air supply system; and,
wherein said electronic control unit is connected by control technology at least to said pneumatic branch-line switching valve.

21. The vehicle of claim 20, wherein said compressed-air consumer is a sensor cleaning device.

22. The vehicle of claim 20, wherein said electronic control unit is configured to connect said compressed-air source to said pneumatic main line depending on at least one of:
a supply requirement of said compressed-air consumer;
sensor signals;
temperature sensor signals of at least one temperature sensor configured to monitor a temperature of said compressed-air generator and to supply the temperature sensor signals; and,
a degree of saturation of said air dryer, wherein said electronic control unit is configured to monitor the degree of saturation.

23. A method for operating a compressed-air supply system, the method comprising:
supplying compressed air at a compressed-air port which is connected to a compressed-air supply port via a pneumatic main line;
separating condensate from moist compressed air, supplied at the compressed-air port, for supplying dehumidified compressed air;
drying the dehumidified compressed air conducted to the compressed-air supply port in a filling direction with an air dryer arranged in the pneumatic main line in a basic operating mode;
supplying the compressed air from the pneumatic main line at the compressed-air supply port in the basic operating mode;
opening a branch line so that air can flow through the branch line pneumatically in a direction of the compressed-air supply port, via a pneumatic branch-line switching valve in a first operating mode; and,
returning the dehumidified compressed air from the branch line through the pneumatic main line counter to the filling direction in the first operating mode.

24. The method of claim 23, further comprising:
blocking the branch line via the pneumatic branch-line switching valve in the basic operating mode;
distributing the compressed air flowing through the branch line in a second operating mode such that a first portion of the compressed air is returned into the pneumatic main line counter to the filling direction and a second portion of the compressed air is supplied at the compressed-air supply port;
Returning the compressed air from at least one of the branch line and the pneumatic main line counter to the filling direction to a second air dryer in a third operating mode;
relieving pressure of the compressed air returned in said returning dehumidified compressed air from the branch line counter to the filling direction in the pneumatic main line; and,
relieving the pressure of the compressed air returned in said returning compressed air from at least one of the branch line and the pneumatic main line counter to the filling direction to the second air dryer in the third operating mode.

25. The method of claim 23, wherein:
the compressed-air supply system includes a compressed-air supply unit having the compressed-air port and a compressed-air generator for supplying the compressed air at the compressed-air port;
the compressed-air supply unit being connected to the compressed-air generator via the compressed-air port, the compressed-air supply unit being for supplying the compressed air for a sensor cleaning device;
the compressed-air supply unit further having the compressed-air supply port for connecting the sensor cleaning device and the pneumatic main line for conducting the compressed air from the compressed-air port to the compressed-air supply port in a filling direction;
the compressed-air supply unit including the air dryer arranged in the pneumatic main line for drying the compressed air conducted in the filling direction;
the compressed-air supply unit further including a throttle associated with the air dryer and a water separator arranged in the pneumatic main line between the compressed-air port and the air dryer;
the compressed-air supply unit further including the branch line departing from the pneumatic main line between the water separator and the air dryer and reconnecting between the air dryer and the compressed-air supply port;
the branch line having a pneumatic branch-line switching valve configured, in a first operating mode, to open the branch line in a direction of the compressed-air supply port so that air can flow through the branch line pneumatically; and,
the compressed-air supply unit being configured, in the first operating mode, to allow return of the compressed air from the branch line through the throttle counter to the filling direction.
